(19) United States
(12) Patent Application Publication
(10) Pub. No.: US 2026/0233576 A1
(43) Pub. Date: Aug. 13, 2026

(54) Vehicle HVAC System for Using Passenger Compartment Heat for Operation

(71) Applicant: MAHLE INTERNATIONAL GMBH, Stuttgart (DE)

(72) Inventors: Edward WOLFE, IV, Stuttgart (DE); Bailey REID, Stuttgart (DE)

(21) Appl. No.: 19/320,937

(22) Filed: Sep. 5, 2025

Related U.S. Application Data
(60) Provisional application No. 63/757,526, filed on Feb. 12, 2025.

(51) Int. Cl. B60H 1/00

(52) U.S. Cl. CPC B60H 1/00564

(57) ABSTRACT

An HVAC system for a vehicle is provided, that includes a system to use passenger compartment heat for heating air within an HVAC system. The system includes a first air inlet configured, when installed within a vehicle, to receive air that flows therein from outside of the vehicle, and a second air inlet different from the first air inlet, the second air inlet configured, when installed within the vehicle, to receive air that flows therein from within a passenger compartment of the vehicle. A heat exchanger disposed to receive air from the first air inlet and the second air inlet via different flow paths simultaneously across different portions of the heat exchanger, and in some embodiments in substantially opposite directions.

### CROSS-REFERENCE TO RELATED APPLICATIONS

This application claims priority from U.S. Provisional Application No. 63/757,526, filed on Feb. 12, 2025, the entirety of which is hereby incorporated by reference herein.

### BACKGROUND OF THE INVENTION

This application is directed to HVAC systems for vehicles, such as passenger vehicles that are always operated with electricity for propulsion and other loads, or for hybrid vehicles that are capable of being operated with electricity for propulsion and other loads. Auxiliary loads require the use of current from the vehicles battery in electric mode and therefore the use of auxiliary loads limits the range of the vehicle. This disclosure relates to improvements within the vehicle to limit the current draw from the battery for various auxiliary loads to improve the range of electric vehicles or hybrid vehicles being operated in electric mode.

### SUMMARY OF THE INVENTION

A representative embodiment of the disclosure is provided. The embodiment includes an HVAC system for a vehicle, including a heat exchanger configured to be disposed within a vehicle, the heat exchanger comprises a first surface and an opposite second surface, wherein a body of the heat exchanger is disposed between the first and second surfaces, wherein the body includes a first portion and a second portion that is different from the first portion;
a first air inlet configured, when installed within the vehicle, to receive air that flows therein from a blower through the first surface, wherein the blower can receive either air from a passenger compartment of the vehicle and/or air from outside of the vehicle, wherein air is directed to flow from the blower into a first portion of the heat exchanger;
a second air inlet different from the first air inlet, the second air inlet disposed to direct air received therethrough into the second portion of the heat exchanger, the second air inlet configured to receive air that flows therein from within a passenger compartment of the vehicle;
the heat exchanger is disposed to direct air from the first air inlet through the first portion of the heat exchanger and the heat exchanger is disposed to direct air from the second air inlet through the second portion of the heat exchanger simultaneously;
a divider positioned across the heat exchanger at a position that establishes a boundary between the first and second positions of the heat exchanger, wherein the boundary prevents or substantially prevents air flowing through the first portion of the heat exchanger from flowing into the second portion of the heat exchanger within a body of the heat exchanger and the boundary prevents or substantially prevents air flowing through the second portion of the heat exchanger from flowing into the first portion of the heat exchanger within the body of the heat exchanger.

Another representative embodiment of the disclosure is provided. The embodiment includes an HVAC system for a vehicle, comprising:
a heat exchanger configured to be disposed within a vehicle, the heat exchanger comprises a first surface and an opposite second surface, wherein a body of the heat exchanger is disposed between the first and second surfaces, wherein the body includes a first portion and a second portion that is different from the first portion;
a first air inlet configured, when installed within the vehicle, to receive air that flows therein from a blower through the first surface, wherein the blower can receive either air from a passenger compartment of the vehicle and/or air from outside of the vehicle, wherein air is directed to flow from the blower through the first inlet and into the first portion of the heat exchanger;
a second air inlet different from the first air inlet, the second air inlet disposed to direct air received therethrough into the second portion of the heat exchanger, the second air inlet configured to receive air that flows therein from within a passenger compartment of the vehicle;
the heat exchanger is disposed to direct air from the first air inlet through the first portion of the heat exchanger and the heat exchanger is disposed to direct air from the second air inlet through the second portion of the heat exchanger simultaneously;
wherein the first air inlet is positioned to cause air flow through the heat exchanger at a first position within the heat exchanger that is vertically above a second position within the heat exchanger,
further comprising a first air outlet configured to receive air from the heat exchanger that flowed from the second air inlet and through the second portion of the heat exchanger, wherein the first air outlet is aligned to direct air that flows into the first air outlet to flow outside of the vehicle,
wherein the second air inlet comprises a first valve disposed therein, wherein the first valve is positionable in a first position to allow air to flow into the heat exchanger through the second air inlet, and a second position to prevent or substantially prevent air to flow into the heat exchanger through the second air inlet,
the first valve extends along a cylindrical profile with an outer circumference that extends along a length thereof between first and second ends, wherein a portion of the outer circumference includes a blocking portion to prevent air flow past the blocking portion and into an inner volume of the cylinder, and a portion of the outer circumference is not blocked to allow flow therethrough and into the inner volume.

Another representative embodiment of the disclosure is provided. The disclosure includes a method of operating an HVAC system for a vehicle, that includes:
providing a heat exchanger configured to be disposed within a vehicle, the heat exchanger comprises a first surface and an opposite second surface, wherein a body of the heat exchanger is disposed between the first and second surfaces, wherein the body includes a first portion and a second portion that is different from the first portion;
a first air inlet configured, when installed within the vehicle, to receive air that flows therein from a blower through the first surface, wherein the blower can receive either air from a passenger compartment of the vehicle and/or air from outside of the vehicle, wherein air is directed to flow from the blower through the first inlet and into the first portion of the heat exchanger;
a second air inlet different from the first air inlet, the second air inlet disposed to direct air received therethrough into the second portion of the heat exchanger, the second air inlet configured to receive air that flows therein from within a passenger compartment of the vehicle;
the heat exchanger is disposed to direct air from the first air inlet through the first portion of the heat exchanger and the heat exchanger is disposed to direct air from the second air inlet through the second portion of the heat exchanger simultaneously;
wherein the first air inlet is positioned to cause air flow through the heat exchanger at a first position within the heat exchanger that is vertically above a second position within the heat exchanger,
further providing a first air outlet configured to receive air from the heat exchanger that flowed from the second air inlet and through the second portion of the heat exchanger, wherein the first air outlet is aligned to direct air that flows into the first air outlet to flow outside of the vehicle,
operating a first valve disposed at the first air inlet, wherein the first valve is positionable in a first position to allow air to flow into the heat exchanger through the second air inlet, and a second position to prevent or substantially prevent air to flow into the heat exchanger through the second air inlet,
operating a second valve disposed downstream of the first air outlet, wherein when the second valve is in a first position air that flows through the second air inlet and the second portion of the heat exchanger can flow through the second valve and toward the second air outlet, and when the second valve is disposed in a second position air that flows through the second air inlet and the second portion of the heat exchanger is prevented from flowing to the second air outlet,
further operating a third valve disposed in conjunction with an air inlet upstream of the blower that controls air flow from a passenger compartment of the vehicle toward the blower, wherein when the third valve is open, air from the passenger compartment of the vehicle is drawn into the HVAC system and into the blower, and when the third valve is closed, air from within the passenger compartment of the vehicle is prevented from being drawn into the HVAC system and into the blower;
wherein a controller is configured to control the positions of the first valve, the second valve, and the third valve,
wherein the controller receives a first input representative of a velocity that the vehicle is traveling,
wherein when the first input indicates that the vehicle is not moving or is moving at a velocity below a threshold velocity, causing by way of the controller the first valve to be in the second position, and the third valve to be in the open position,
   wherein when the first input indicates that the vehicle is moving at a velocity above the threshold velocity, causing by way of the controller the first valve and the second valve to each move to the first position.

The heat exchanger may be an evaporator from an air conditioning system or a heat pump system.

The heat exchanger may be a cooler from a vehicle coolant system.

The representative embodiment of the paragraphs above may include the structure that is described in one or more of the Numbered Paragraphs 1-45 provided at the end of the specification of this application.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a perspective view of an HVAC system that includes a system for providing recirculating passenger compartment air to heat intake air.

FIG. 2 is a side partial cross-sectional view of a portion of the air flow housing of the HVAC system of FIG. 1.

FIG. 3 is a schematic view of a portion of the HVAC system of FIG. 1 wherein the heat exchanger (20) is aligned within a heat pump system to receive refrigerant within the heat pump system.

FIG. 4 is the view of the HVAC system of FIG. 3 aligned for natural circulation heating of the intake air (Z) with heat from the passenger compartment.

FIG. 5 is a schematic view of a portion of a different HVAC system of FIG. 1, wherein the heat exchanger (120) is aligned to receive coolant from an air conditioning system.

FIG. 6 is the view of the HVAC system of FIG. 5 aligned for local circulation of coolant for heating the air intake (Z) with heat from the passenger compartment.

FIG. 7 is a cross-sectional side view of an HVAC system of any one of FIGS. 1-6 that includes a modified second valve that is formed as a barrel valve, with the second valve in a first position to allow air flow from the heat exchanger to the relief system outlet.

FIG. 8 is the cross-sectional view of FIG. 7 showing the second valve in a second position that prevents air flow from the heat exchanger to the relief system outlet.

FIG. 9 is a cross-sectional perspective view that shows the second valve in the position of FIG. 8.

FIG. 10 is a perspective view of the second valve.

FIG. 11 is a perspective view of a heat exchanger that can be used with the HVAC systems disclosed herein.

FIG. 11A is a detail view of detail AAA of FIG. 11.

FIG. 12 is a perspective view of the heat exchanger with the dividers 612A, 612B partially installed therewithin.

FIG. 13 is a perspective view of the two dividers that can be used with the heat exchanger of FIG. 11.

FIG. 14 is a cross-sectional view depicting the heat exchanger of FIG. 11 schematically depicting various air flow through the heat exchanger.

FIG. 15 is a cross-sectional view of the HVAC system depicting the first valve in the first position to block passenger air from flowing into a second portion of the heat exchanger.

FIG. 16 is the view of FIG. 15 depicting the first valve in the second position, allowing passenger air flow into the second portion of the heat exchanger, but preventing air flow leaving the first portion of the heat exchanger from flowing to a plenum for floor vents/rear vents that bypasses the heating element.

FIG. 17 is the view of FIG. 15 depicting the first valve in the third position, allowing passenger air flow into the second portion of the heat exchanger, and allowing flow leaving the first portion of the heat exchanger to flow to a plenum for floor vents/rear vents while bypassing the heating element.

FIG. 18 is a graph that depicts the positions (percent open—y-axis) of the first valve (72/572), the second valve (74/174—annotated with “#” symbols for ease of understanding), and the third valve (820—annotated with stars for ease of understanding) with respect to the forward vehicle speed (x-axis).

FIG. 19 depicts a fluid flow diagram of a coolant system with a cooler 120 that includes one or more of the features disclosed herein.

### DETAILED DESCRIPTION OF THE INVENTION

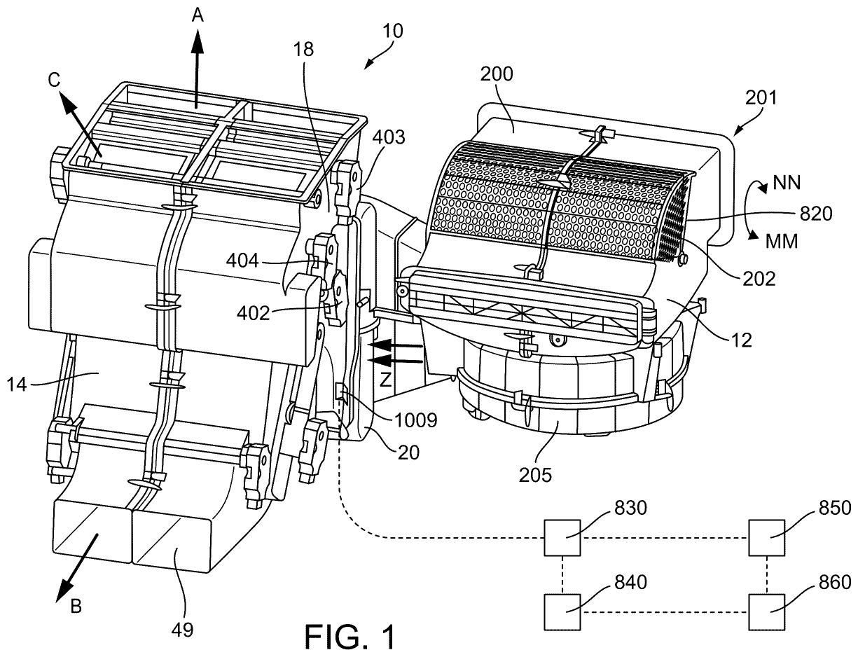

Turning now to FIGS. 1-19, a HVAC (heating, ventilation, and air conditioning) system 10, 100 is provided. The HVAC system 10, 100 is described herein as provided within a vehicle, such as a passenger vehicle, but the HVAC system can readily alternatively be provided for other types of vehicles or machines that include passenger or operator compartments with controlled air conditioning, heating, and the like, such as cranes, tractors, trains, aircraft, ships, as well as area spaces, and the like. For the sake of brevity, the HVAC system 10, 100 is only discussed for use in a passenger vehicle, but one of ordinary skill with a thorough review and understanding of this specification will readily appreciate that the HVAC system 10, 100 can also be used for other vehicles, machines, and spaces with conditioned air flow, with a modifications to the systems 10, 100 that would be appropriate for the different uses as discussed below.

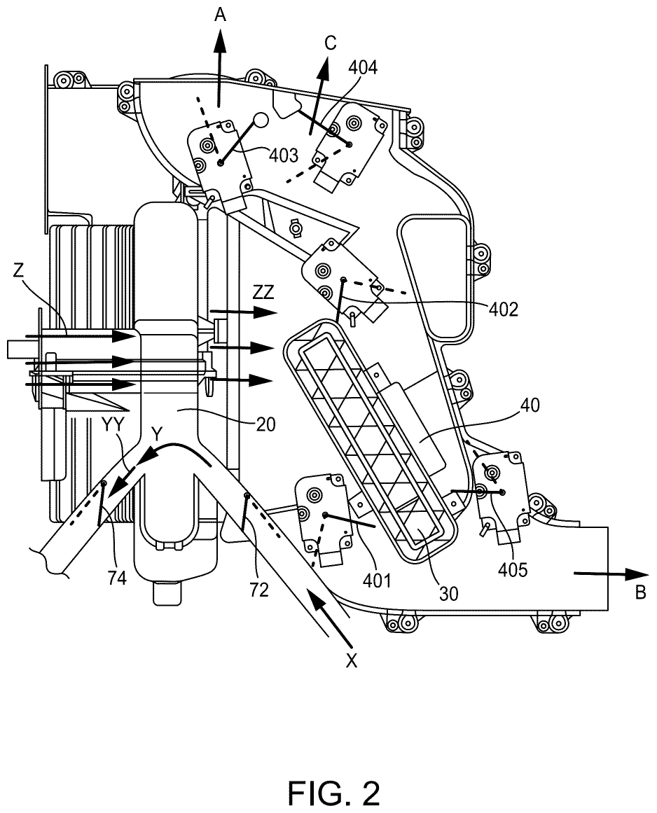

The HVAC system 10, 100 may be a portion of a fully HVAC system for a vehicle, and include air inlets from one or both of outside air 201 (i.e. air not from the passenger compartment), air from the passenger compartment 202 (also referred to as recirc. air herein), and is shown in FIGS. 1 and 2. The HVAC system receives the air inlet, typically via the discharge of a fan (within fan housing 205, FIG. 1) that receives the intake air, and send the air through a first heat exchanger (20, 120), with an air flow schematically depicted as Z in the figures. The air leaving the heat exchanger 20, 120 (schematically depicted as ZZ in the figures) may then travel through a second heat exchanger (30, 130, typically a heater) or it may bypass the second heat exchanger 30, 130. The air ZZ (whether it travels through or bypasses the second heat exchanger 30, 130) then may be sent to one of a plurality of outlets of the HVAC system based upon the position of a plurality of valves (e.g. 401, 402) as controlled by the HVAC controller. For example, the valves may be positioned such that the air is sent to the defrost outlet (A) to apply heated air to defrost the front windshield and potentially other windows in the vehicle. Alternatively, the air may be sent to the panel outlets (C), and/or it may be sent to the floor outlets (B). FIG. 2 depicts the plurality of valves 401, 402, 403, 404, 405 with each valve in its two possible positions, one position with a solid line and the second position with a dashed line (the valves may also be an intermediate position to allow reduced air flow as can be well understood.

Air that is drawn into the HVAC may either be outside air, which enters the HVAC system through inlet 201 (FIG. 1) or it may be passenger compartment air (also called recirc. air) which enters the HVAC system through inlet 202. The HVAC controller 1009 (FIG. 1, schematic) may control the position of valves within the inlet housing 200 (valves not shown) that either allow recirc. and prevent outside air, allow outside air and prevent recirc. air, or are throttled to allow a combination of recirc. and outside air. The air that enters the housing 200 then flows through the fan (within housing 205) and flows to the heat exchanger 20/120 as discussed below. The housing 200 may be the same for both HVAC systems 10 and 100 discussed below.

The HVAC systems 10, 100 are provided to allow for heating the inlet air Z into the HVAC with heat that is already within the passenger compartment, to minimize the input of heat necessary (by the HVAC system, and specifically the HVAC heater 30, 130) to be added to the air that is used for the defrost cycle (flow A through the HVAC system—FIGS. 1 and 2). Specifically, air from outside the vehicle is typically used for defrost air (flow A) because the outside air includes a much lower relative humidity (and therefore due point) than the air within the passenger compartment (due to the presence of passengers within the passenger compartment who continuously give off moisture to air within the passenger compartment). In situations where the defrost is needed (i.e. when frost has or threatens to build up on the windshield or other windows, or fog collects on the windshield) the outside air is typically very cold and therefore needs to be heated before reaching the windshield to remove the frost/fog from the windshield. With conventional HVAC systems, the air (Z, ZZ—FIGS. 1, 2) flows through heater 30 of the HVAC system that is either a coolant heat exchanger for systems with an engine or in systems with a heat pump the heating element is a heat pump heater (condensing function) that is part of the heat pump system, and the system may also include an electrical heater 40 (e.g. PTC heater or resistance heater) that is positioned in series with the heat pump heater and is operated by the HVAC controller if extra heat above the heat provided by the heat pump heater 30 is needed. The electrical power either is provided by current generated by the alternator in a vehicle with an internal combustion engine or for electric vehicles (either complete electric vehicles, or hybrid vehicles that are currently being powered by the battery) the electrical power is provided by the vehicle's battery. The use of the vehicle battery to power the heater 30, 130 limits the range of the vehicle.

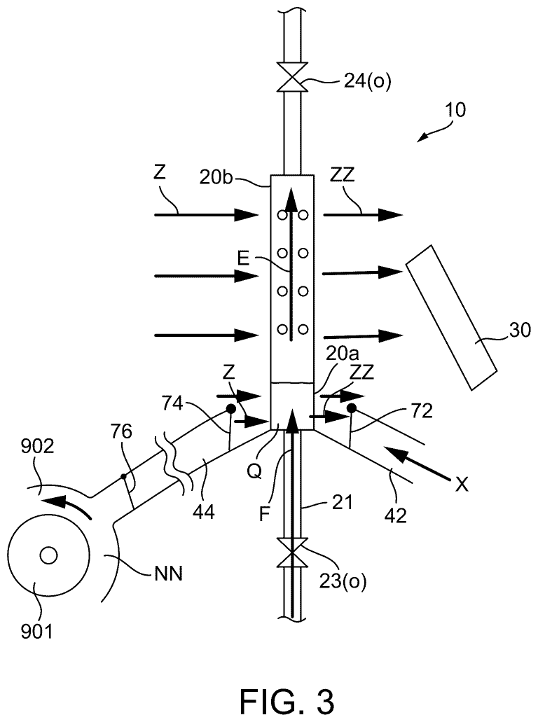

The heat exchanger 20, 120 that is provided within the HVAC system 10, 100 to solve the problems with current HVAC units in electrically powered vehicles (discussed above) is provided and is depicted in detail in FIGS. 3-6. Heat exchanger 20 is a heat exchanger that is associated with a heat pump system or an air conditioning system—both with circulating heat exchange fluid (i.e. refrigerant) heat exchange fluid as driven by a compressor or pump (not shown) where the heat exchanger 20 forms the evaporator of a typical heat pump/AC system, which during operation typically removes heat from the air that crosses past the evaporator (schematically air flow Z). The operation of a heat pump system (which also typically includes a compressor, expansion valve, and a condenser—each not shown) is well understood. The HVAC system 10 includes modifications to the heat exchanger 20 that allow the heat exchanger 20 to operate with natural circulation of the refrigerant (from the heat pump system) that is within the heat exchanger/evaporator 20, rather than with typical forced refrigerant circulation within the heat pump system (as urged by the compressor, and the thermodynamic changes with the refrigerant during normal operation of the heat pump system). Heat exchanger 120 is discussed separately below.

In some embodiments, the heat exchanger 20/120 may include a plurality of tubes to receive and enclose the refrigerant or coolant therein, and allow the refrigerant or coolant to flow therethrough (normal operations of the HVAC system) or to maintain the isolated refrigerant or coolant therein, i.e. the natural circulation embodiments discussed herein. The heat exchanger 20/120 may include a plurality of fins (or louvers) that either extend outward from one or more of the tubes and in some embodiments bridge multiple tubes. The air flow Z to the heat exchanger flows over the outside of the tubes and the plurality of fins to maximize the surfaces that the air flow contacts for maximum convection heat transfer. In some embodiments, some of the fins may be of open construction (i.e. to allow air to flow through the fin as well as across the surface of the fin) to generate turbulent air flow across the fins to further increase heat transfer. In some embodiments, some of the fins may be closed construction, with the fins with open and closed construction being positioned to allow for differing amounts of heat transfer at different locations along the length of the heat exchanger 20/120. In one embodiment, open fins may be provided at the locations of the heat exchanger where air flow Z from the fan is received, and also open fins may be provided at the lower portion of the heat exchanger where air flow X from the passenger compartment is received (both flow paths discussed in detail below) with some closed fins provided in a space between the positions where air flows Z and X will be received.

Heat exchanger 20 receives refrigerant therein (shown schematically as Q in FIG. 3) based upon its connection with the remainder of the heat pump system. A first line 21 is connected to the heat exchanger 20 at a lower portion 20a of the heat exchanger (as the HVAC system is installed within a vehicle or other machine with respect to the force of gravity) and a second line 22 is connected to the heat exchanger 20 at a high portion 20b that is vertically above the lower portion 20a. The first line 21 includes a first valve 23 that can be open (O) or shut (S) to allow refrigerant flow or prevent refrigerant flow therethrough, respectively. Similarly, the second line 22 includes a second valve 24 that can be open (O) or shut (S) to allow refrigerant flow or prevent refrigerant flow therethrough, respectively. The first valve 23 is at the refrigerant inlet of the heat exchanger 20. This valve may be a typical isolation valve that can be controlled by the HVAC controller to either an open or shut position. Alternatively, the valve 23 may be the TXV (thermostatic expansion valve) and not a conventional isolation valve. The TXV may be fixed in position. Alternatively, the valve 23 may be an EXV (electronic expansion valve) that is operated by the HVAC controller to alter its position. In some embodiments, when the compressor of the heat pump (or air conditioning) system is not operating, there is no refrigerant flow through the TXV or EXV so that the TXV/EXV operates as an isolation valve in the natural circulation operational state discussed herein. Alternatively, the construction of the heat exchanger 20 may be altered such that the first line 21 and first valve (which may be the TXV or an EXV) is positioned vertically above the heat exchanger, and the second line 22 and second valve 24 is below the heat exchanger. In still other embodiments, both valve 23 and the TXV—or EXV) may be provided in series with the valve 23 being controlled by the HVAC controller.

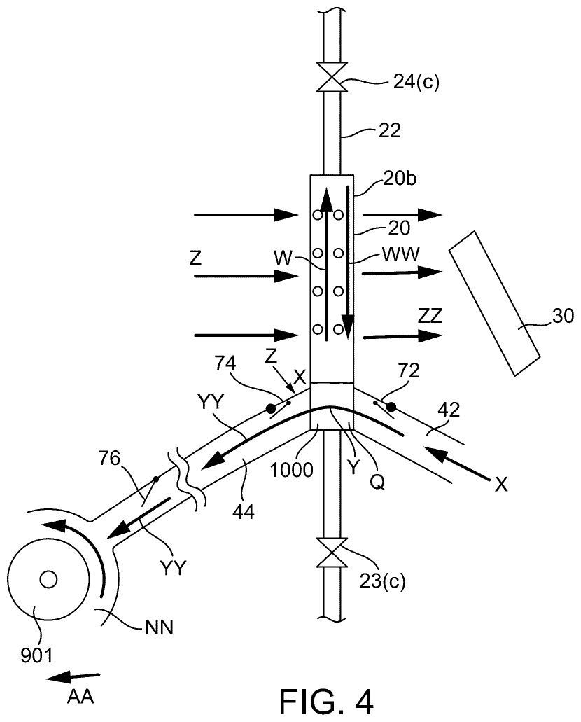

In embodiments where the TXV or EXV of a heat pump system are used for the valve 23, the position of the TXV or EXV may maintain constant (or as controlled by the HVAC controller for the EXV) in both the regular operations (FIG. 3) and the natural circulation operations (FIG. 4). In this embodiment, because during natural circulation operations the compressor (not shown) is not operating, no refrigerant flows through the TXV/EXV in this situation, so from the perspective of refrigerant within the system the valve (23) is “shut” (as depicted on FIG. 4)—i.e. refrigerant does not flow through the valve 23 (TXV, EXV) or only a di minimus amount of refrigerant flows through the valve 23 (TXV, EXV) which specifically is included within this definition of “does not flow through the valve” as used herein.

A relief air flow path 42, 44 is provided with respect to the heat exchanger 20. The term relief is used herein because this air flow path may be one of a plurality of relief flow paths to prevent overpressure within the passenger compartment and to minimize pressure transients within the passenger compartments, such as when open or closing doors or with deployment of one or more airbags. The passenger compartment may include additional relief flow paths in addition to the flow paths 42, 44, to continue to provide passenger compartment overpressure protection in situations where one or both of the inlet and outlet valves 72, 74, 76, 174 are shut, as discussed herein. In some embodiments, the flow path 42, 44 may not be designed to provide any overpressure protection and the passenger compartment may include other pressure relief flow paths. The term relief is used herein to describe the flow path 42, 44 for the sake of simplicity—but one of ordinary skill in the art with a thorough review and understanding of this specification will understand that it is within the scope of this specification to provide for the flow paths 42, 44 without passenger compartment overpressure protection being an intended (or actual, depending upon the positions of the valves) function. The term auxiliary air flow path may be used instead of relief to denote the flow paths 42, 44 and associated components and functionality of the system—and the use of term auxiliary air flow path does not result in a change of scope of the system described herein unless specifically noted below. The relief air flow path 42, 44 (or auxiliary flow path)—for the sake of brevity the term relief flow path will only be used below, but one or ordinary skill in the art will understand that the term auxiliary flow path could be replaced for relief flow path unless specifically noted below). The term recirculation as used in the priority application is referring to the relief system discussed herein. The relief air flow path 42, 44 The relief air flow path 42, 44 may disposed to direct air flowing therethrough across the heat exchanger 20 at or proximate to the lower portion 20a of the heat exchanger 20. The relief air flow path 42, 44 is disposed vertically below the entirety or an significant majority of the location upon the heat exchanger where the air flow Z from the fan 205 flows across the heat exchanger 20. The term significant majority includes a percentage of flow greater than 50%, and in preferred embodiments between 70% to 100% including all values of flow within this range. In some embodiments, the relief air flow path 42, 44 is disposed below about 95% of the air flow Z from the fan 205, while in other embodiments, below about 90%, 85%, 80%, 75%, 70%, 65%, 60%, 55% and just above 50% of the air flow Z across the heat exchanger 20.

The relief air flow path includes an inlet portion 42 that directs air receive (X, schematic) toward and across the heat exchanger 20. The inlet portion 42 is configured to receive air X from the passenger compartment, i.e. recirc. air. The air X may be received from the passenger compartment via a different air source than the recirc. air 202 that flows into the air inlet housing 200 of the HVAC system, or it may be from the same air source as the recirc. air 202 that flows into the inlet housing 200, with the same air source having different flow path branches to provide the air to recirc. air inlet 202 and to the inlet portion 42.

The inlet portion 42 includes an inlet valve 72 that is controlled by the HVAC controller and includes a first position to completely or substantially prevent air flow X through the inlet portion 42 to the heat exchanger 20 (FIG. 3) or it may be in a second open position to allow air flow X through the inlet portion 42 to the heat exchanger 20 (FIG. 4). The term “substantially prevent” is defined herein to mean blocking the overwhelming majority of air flow X, but allowing some di minimus amount of flow past the valve—such as due to an imperfect connection between the valve seat at the walls of the portion 42 that provides some space for unintended air to flow therepast.

The air flow across the heat exchanger Z from the inlet housing 200 and fan 205, which is directed into the remainder of the HVAC and ultimately to the desired use (e.g. the defrost, A, cabin C, rear row B) flows past the heat exchanger 20 in a first direction (e.g. from left to right as FIGS. 3 and 4 are printed on the page) and the air flowing from the air inlet portion 42 across the heat exchanger 20 and to the air outlet portion 44 flows (X, Y) in the opposite direction (or substantially opposite direction), i.e. from the right to the left as FIGS. 3 and 4 are printed on the page). The term opposite directions means directions along lines that are parallel with each other, but extend in the opposite way along the line (e.g. one being right to left on the page, the other being left to right on the page). The term substantially opposite directions means two directions that are nearly parallel with each other, but may be different from being mathematically parallel with each other with a minor acute angle between the two lines forming the directions, such as 20 degrees or less. The minor acute angle may be a 2D angle (i.e. two vector components) although it may also be a 3D angle (i.e. with three differing vector components, but the differing vector components each differ with an angle of 20 degrees or less). In another embodiment, the air flow Z may flow through the heat exchanger 20 in the same or substantially the same direction as the flow from the air inlet portion 42, across the heat exchanger 20, and to the outlet portion 44 flows (X, Y). In this embodiment, FIGS. 3 and 4 would be redrawn with the inlet 42 appearing on the left side of the heat exchanger 20 (as drawn on the figure) and the air outlet 44 being on the right side of the heat exchanger, with flow Y moving from left to right across the heat exchanger 20. The term substantially the same means two directions that are nearly parallel with each other, but may be different from being mathematically parallel with each other with a minor acute angle between the two lines forming the directions, such as 20 degrees or less. The minor acute angle may be a 2D angle (i.e. two vector components) although it may also be a 3D angle (i.e. with three differing vector components, but the differing vector components each differ with an angle of 20 degrees or less). In yet another embodiment, the air inlet and outlet 42, 44 could be rearranged with respect to the heat exchanger such that the flow Y through the heat exchanger is in a direction into our out of the page of FIG. 4 (either exactly into or out of the page, or with a vector component that is into or out of the page).

The outlet portion 44 includes an outlet valve 74 that is controlled by the HVAC controller and includes a first position to completely or substantially prevent air flow YY from the heat exchanger 20 (FIG. 3) or it may be in a second open position to allow air flow YY from the heat exchanger 20 and through the outlet portion 44. The positions of the first and second valves 72, 74 are preferably controlled by the HVAC controller 1009 to be the same in all modes of operation of the HVAC system. In some embodiments, only one of the first or the second valves 72, 74 is provided, with the single valve (either within the inlet portion 42 or the 44) position either allowing or preventing air flow from the passenger compartment to flow through the inlet and outlet portions 42, 44.

The outlet portion 44 may extend between the heat exchanger 20 a position where the air that flows therethrough YY extends to an outlet 44b that is at a location at or proximate to with an unimpeded air flow path to outside of the vehicle. An exit valve 76 may be provided proximate to the outlet end 44b. In some embodiments, the exit valve 76 may be a check valve that allows flow YY in the direction of flow from the heat exchanger 20 to the outlet 44b, but substantially prevents flow in the reverse direction from the outlet 44b to the heat exchanger 20. In other embodiments, the exit valve 76 may be a remotely operable valve as operated by the HVAC controller (1009) and maintained in the same position as the outlet valve 74. In other embodiments, only the exit valve 76 may be provided (and the inlet and outlet valves 72, 74 are not provided). In this embodiment, the exit valve 76 may be a remotely controlled valve as controlled by the HVAC controller, with the position of the exit valve 76 either allowing or preventing the air flow from the passenger compartment through inlet and outlet lines 42, 44 and eventually out of the vehicle. In this embodiment, the exit valve 76 is a normally closed valve, and may be remotely opened when it is desired to have the relief air flow from the passenger compartment through the heat exchanger 20/120 and out of the vehicle.

In some embodiments, the outlet end 44b of the outlet portion 44 may be disposed at a position within the vehicle that has a negative pressure (vacuum), such as during operation of the vehicle. For example, at certain speeds of certain vehicles, a position (NN) within the vehicle's wheel well 902 proximate to the rear portion of the tire 901 (i.e. the portion of the tire 901 that faces (either directly or with a horizontal vector component) the rear of the vehicle, i.e. faces away from the direction of forward motion (arrow AA) of the vehicle (with the tire rotating as shown with the arrow in FIG. 3)) may be at a small negative pressure. The position of the outlet end 44b either at atmospheric pressure, or at a small negative pressure assists with flow through the inlet and outlet portions 42, 44 (flows X, Y, YY) and across the heat exchanger 20. In other embodiments, the outlet end 44b may be located at other locations within the vehicle than the wheel well where the air can flow through the outlet end 44b and to the outside with minimal air resistance (to avoid creating back pressure within the outlet portion 44). In some embodiments, one or both of the inlet or outlet portions 42, 44 may include a fan (not shown, but conventional) that urges flow through the inlet (direction X) or through the outlet (flow YY) each of which will urge flow Y through the heat exchanger 20. The fan may constantly operate, or may be operated by the HVAC controller to cause air flow Y when desired.

FIG. 4 is a schematic view of the HVAC system 10 that is aligned for natural circulation within the heat exchanger 20. The heat exchanger 20 is provided to remove heat from the recirc. air flow X through the inlet portion 42 as it passes the heat exchanger 20 (Y, and leaves the heat exchanger YY through the outlet portion 44) and provide the removed heat to the air Z that flows past the heat exchanger 20 from the air inlet housing 200. As depicted schematically in FIG. 4, recirc. air X flows past the heat exchanger 20 (Y) and specifically past a lower portion 20a of the heat exchanger 20 that includes liquid refrigerant (Q) or a combination of liquid refrigerant and refrigerant vapor, which is at a low pressure. In FIG. 4, valves 23 and 24 are closed so that there is no flow of refrigerant Q into our out of the heat exchanger 20. The air X, Y that flows across the bottom portion of the heat exchanger transfers heat from the air to the heat exchanger and specifically to the refrigerant Q proximate the air flow Y. This refrigerant (due to the low pressure within the heat exchanger 20) turns to vapor and therefore rises within the heat exchanger (arrow W) until it reaches a vertical position where it is aligned with the inlet air path Z (FIG. 4). The heat from the refrigerant is transferred to the lower temperature air flow Z, which increases the temperature of the air leaving the heat exchanger ZZ. This hotter air may directly flow to the defrost outlet (A) based upon the position of valves 402, 403 (FIG. 2) or it may be directed to flow through the heating element 30 in the event that more heat is needed to increase the temperature of the air ZZ to be usable for defrost purposes (A). In this case, the preheating of the air Z to ZZ within the heat exchanger decreases the amount of heat that needs to be provided by the heating element 30 (than if the system discussed herein was not provided or not operating), which reduces the current needed from the battery (or eliminates the current needed if the air ZZ is heated to the suitable temperature only by the heat exchanger 20.

As the heat from the refrigerant Q is transferred to the air Z to ZZ that flows past the heat exchanger 20, the refrigerant in some circumstances, or after giving off sufficient heat will condense into liquid form and fall to the lower portion 20a of the heat exchanger 20 (arrows WW), where the process continues with receiving heat from the recirc. air X, Y that flows past the lower portion 20a of the heat exchanger 20. This cycle continues as heat from the passenger compartment (via the recirc. air) is effectively transferred to the air flow Z from outside the vehicle (lower humidity than the recirc. air) to allow for the outside air to be used for the defrost cycle and for passenger compartment heating. This allows for heat to be provided at much less electrical current than would be necessary with convention operation of the HVAC system 10 with all of the heat input coming from the heater (due to heat pump system compressor operation to provide heat at the heater 30 and due to resistance heat from the secondary heater 40). In some embodiments, an air blower (not shown, conventional and upstream of valve 72) may be provided to urge recirc. air X to flow through the air inlet 42 and across the lower portion 20a of the heat exchanger and out the outlet 44 (in some embodiments as further aided by the negative pressure at the outlet 44b when the vehicle is moving in the forward direction.

After the need to use by the system in natural circulation mode is no longer needed (either automatically sensed by the HVAC controller, or with a passenger input) the HVAC controller (1009, schematic) reorients the operation of the HVAC system to operate as a typical heat pump system that provides a heat input to the air solely from the heat pump heater 30 and/or solely with the electrical heater 40 as needed. In either case, the HVAC controller 1009 may open valves 23 and 24 to allow refrigerant flow through the entire heat pump system, (with or without the compressor operation—as needed for the desired temperature of the air flow) and the HVAC controller changes the position of the various valves (401-405) as needed to generate the desired air flow(s) by the HVAC system.

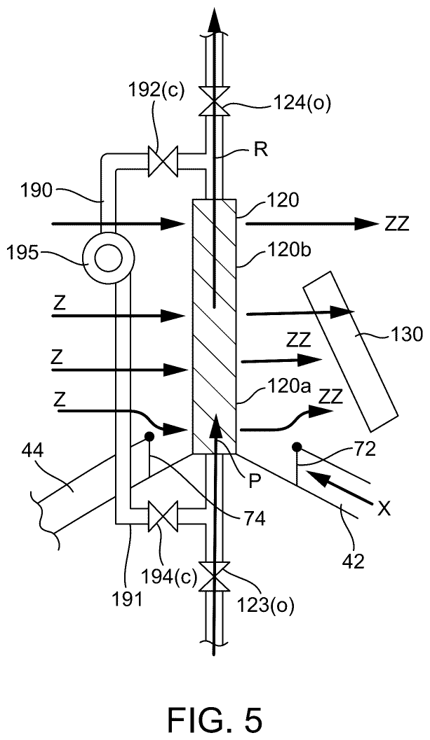

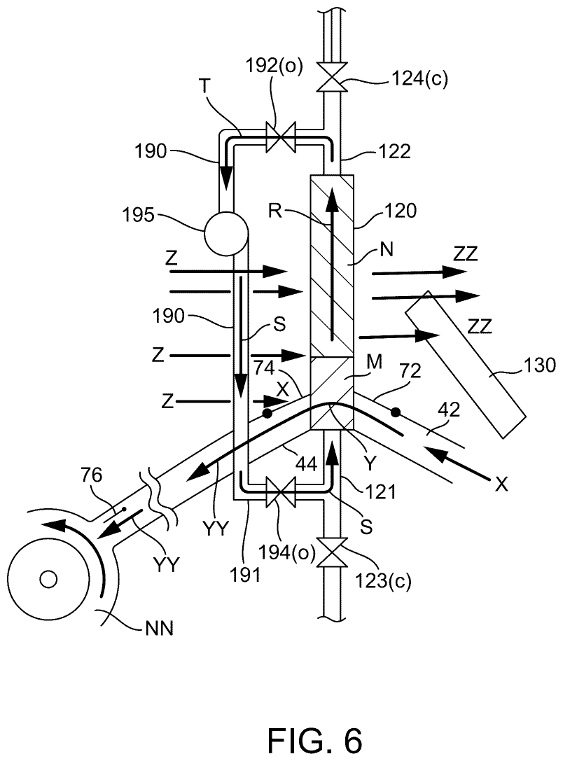

Turning now to FIGS. 5-6, the HVAC system 100 is similar to system 10, but used with an indirect system, such that the heat exchanger 120 is configured to receive heat exchange fluid that is vehicle coolant, rather than refrigerant. The vehicle coolant is cooled/heated as appropriate by a heat pump system (i.e. a chiller or a condenser as appropriate), but this heat transfer (i.e. the direct heat transfer) occurs outside of the HVAC system. In this embodiment, the heat exchanger 120 is a load on the HVAC system (e.g. the chiller) similar to other loads, e.g. the battery, brakes, etc. In some embodiments, the vehicle coolant that is provided to the heat exchanger 120 may selectively flow from the chiller (of a heat pump system) and/or it may flow from a radiator at the front end of the vehicle, with the cooling of the coolant provided by the convection heat transfer of the moving air past the radiator as the vehicle moves in the forward direction. A vehicle controller (or the HVAC controller 1009) may in this embodiment operate various isolation valves to control whether the coolant that reaches the heat exchanger 120 flows through the chiller of the heat pump system, the radiator, or both.

The system 100 includes inlet and outlet portions 42, 44 that receive air from the passenger compartment (X) and allows flow of the air past the heat exchanger 120 (flow Y) and flow leaving the heat exchanger (flow YY) to flow outside of the vehicle, as with the system 10. The inlet and outlet portions 42 and 44 of system 100 may be designed and operated by the HVAC controller 1009 in the inlet and outlet portions 42, 44 of the system 10 discussed above.

The heat exchanger 120 is provided within a coolant system. The heat exchanger includes a coolant inlet 121 and a coolant outlet 122, both of which include isolation valves 123, 124, respectively. The heat exchanger 120 additionally includes a bypass line 190/191 that extends from the coolant outlet 122 (on the heat exchanger side of the valve 124), through a pump 195 and returns to the coolant inlet 121 (on the heat exchanger side of the valve 123). In some embodiments, the bypass line 190/191 may have isolation valves 192, 194 that are provided proximate to the respective connections between the bypass line 190 and the coolant outlet 122, and the bypass line 191 and the coolant inlet 121, respectively. The valves 123, 124, 192, 193 may be remotely operable valves that are operated by the HVAC controller 1009, depending upon the desired operation of the HVAC system.

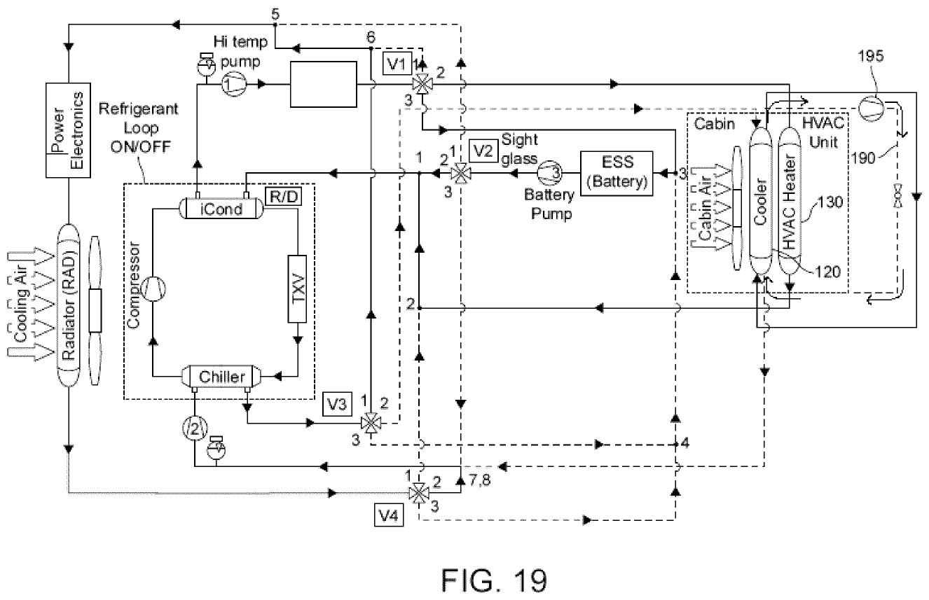

Alternatively, with reference to FIG. 19 the heat exchanger 120 is provided within a full cooling system 2000 of a vehicle, and includes the bypass line 190 that allows flow of coolant into and out of the cooler. FIG. 19 depicts a pump 195, but this pump may not be needed, i.e. the coolant flow may flow through path 190 via natural circulation.

During normal operations of the HVAC system 100 (e.g. providing heated or cooled air to the passenger compartment) valves 123, 124 are open and valves 192, 193 are shut (FIG. 5) which allows a continuous flow of coolant through the heat exchanger 120 (flows P and R), such as when it is desired to provide cool air (which may be air conditioning) or simply air flow through the HVAC and into the passenger compartment.

The HVAC 100 may be set up for local coolant circulation as is depicted in FIG. 6. This, similar to the HVAC 10 discussed above (FIG. 4) the local coolant circulation allows for heat for the passenger compartment to provide heat to the intake air (flow Z, FIG. 6) that flows across the heat exchanger 120 to minimize or eliminate the need to operate the heating module 130—which draws current from the vehicle's battery when operating on electricity (either a fully electric vehicle or a hybrid vehicle operating with electrical power currently).

As depicted in FIG. 6, the inlet valve 72 may be opened which allows recirc. air from the passenger compartment to flow through the air inlet portion 42 and across the lower portion 120a of the heat exchanger 120 (and specifically the portion M of the heat exchanger with hatching on FIG. 6 that extends from 8 o'clock to 2 o'clock on a clock face). During this mode of operation valves 123 and 124 are shut, which prevents the coolant within the heat exchanger 120 from flowing back to the chiller (or radiator) to remove the heat from the coolant. Instead, valves 192 and 193 are open and the pump operates 195, which causes flow from section 190 to section 191 of the bypass line, and therefore causes coolant to flow into the heat exchanger at the lower portion 120a and flow upwardly through the heat exchanger 120 to the upper portion 120b.

Air (Z) from the HVAC fan 205 flows across the heat exchanger 120 (and specifically across the upper portion 120b of the heat exchanger 120 (and specifically the portion N with hatches that extend from 10 o'clock to 4 o'clock on the clock face). Because the coolant flows in the direction R through the heat exchanger 120, the coolant receives heat from the recirc. air (Y) that flows across portion M (the recirc. air flows from the relatively warm passenger compartment into the inlet line 42 and to the heat exchanger), which increases the temperature of the coolant. The coolant that reaches the upper portion 120b (M) has an increased temperature and therefore heat transfers from the coolant to the air Z that flows from the HVAC fan 205, thereby increasing the temperature of the air ZZ that leaves the heat exchanger 120 and travels to the desired outlet path (typically in this instance the defrost—air flow A (FIGS. 1, 2).

Depending upon the temperature difference between the air Z and the passenger compartment air X, the air ZZ may need to be further heated by the HVAC heater 130 to reach a temperature needed for suitable defrost, but the introduction of heat from the heat exchanger 120 minimizes the amount of heat needed by the HVAC heater 130—thereby limiting the current draw from the battery to operate the defrost. In some embodiments, particularly after sufficient time of operating the system 100 in the configuration of FIG. 6 (as well as the system 10 in the configuration of FIG. 4), the HVAC controller may determine that the air temperature ZZ (which was further heated after the heat exchanger 120 (20) by the HVAC heater 130 (30)) is such that it no longer needs the extra heat from the HVAC heater 130, 30 and the HVAC controller 1009 may turn off the HVAC heater 130/30 and may redirect the air ZZ within the HVAC to bypass the HVAC heater.

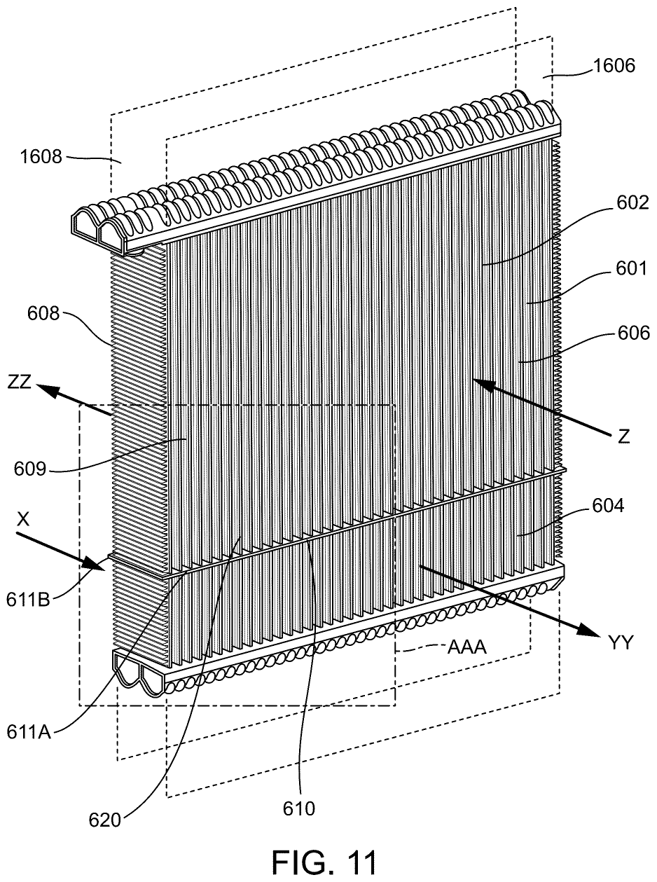

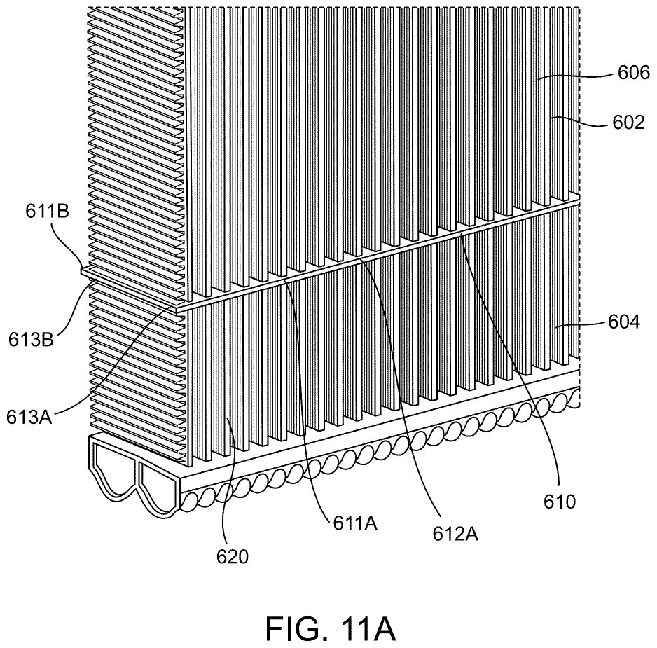

Turning now to FIGS. 11-14, a modified heat exchanger 601 is provided. The heat exchanger 601 can be used in the system where the heat exchanger 20 is provided or can be used in the system where the heat exchanger 120 is provided. Other than the modifications to the heat exchanger 601 discussed herein, the heat exchanger is the same as the heat exchangers 20/120 discussed herein—and for the sake of brevity the user will understand that the heat exchanger 20/120 can include the structure of heat exchanger 601 disclosed below and therefore heat exchangers 20/120 discussed below will also include a disclosure of a modification to the form of heat exchanger 601.

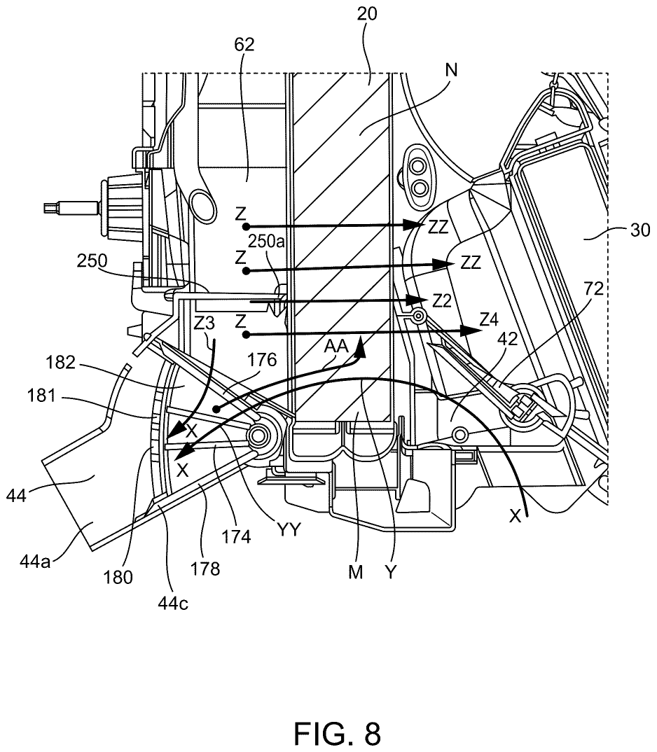

The heat exchanger 601 includes a physically divided first portion 602 and a second portion 604. The first portion 602 is the area where air Z from the blower (within fan housing 205) is received and flows therethrough as depicted as air ZZ in the figures. The second portion 604 is the area where air flow X from the passenger compartment is received and flows from the heat exchanger (air flow YY), as discussed in the embodiments herein. In some embodiments, when the valve 74/174 is aligned to block the second outlet 76, the air flow Z from the blower can also flow through the second portion 604 of the heat exchanger (flow Z4, FIG. 8), with air Z entering the heat exchanger from the first surface 606 and leaving through the second surface 608.

The heat exchanger includes a divider 610 that is disposed across the heat exchanger and establishes a barrier between the first and second portions 602, 604 to prevent or substantially prevent air flow from the first portion 602 into the second portion 604 within the body 609 of the heat exchanger and prevent air flow from the second portion 604 and into the first portion 602 within the body 609 of the heat exchanger. The body 609 of the heat exchanger establishes the air cross-flow profile through the heat exchanger. The term “substantially prevent” is defined herein to mean preventing an overwhelming majority of flow between the first and second portion, but allowing some di minimus amount of flow—such as due to an imperfect meeting one or more tip portions 615A, 615B of opposite fingers 613A, 613B when the two dividers portions 611A, 611B are assembled, or due to tolerance buildup.

The heat exchanger includes a first surface 606 that establishes an inlet for air flow Z from the blower, and a second surface 608 that establishes an outlet for air flow ZZ. The divider 610 establishes a barrier that results in air that enters into the first portion 602 of the heat exchanger via the first surface 606 to also leave the first portion 602 via the second surface 608, thereby preventing air flow within the body 609 to flow from the first portion 602 to the second portion 604 and vice versa. Similarly, the divider 610 establishes a barrier that results in air that enters into the second portion 604 (typically through the second surface 608) to also leave the heat exchanger from the second portion 604.

In some embodiments as discussed above, a small central gap XXX may be provided within the divider 610 that would allow some air flow within the body 609 to flow from the first portion 602 to the second portion 604 or from the second portion to the first portion, but this gap when provided has a very small width in comparison to the overall width of the heat exchanger. In this embodiment, the air is substantially prevented from flowing from the first portion to the second portion and vice versa—with substantially preventing being further defined as allowing only a di minimus amount of air flow that is commiserate with a gap that has a width that is between 2.5 and 5% of the overall width of the body 609. For example, in one embodiment, the width of the body 609 (e.g. the horizontal distance that air flows through the body between the first and second surface 606, 608) is 40 mm and the gap XXX is 1-2 mm.

In some embodiments, the heat exchanger 601 is provided such that the first portion 602 is positioned vertically above the second portion 604 when the heat exchanger 601 is installed within a vehicle. The divider 610 extends along the body of the heat exchanger from the first surface 606 to the second surface 608. In some embodiments, the divider 610 is positioned perpendicular to a plane 1606 that extends along the first surface 606, and extends perpendicular to a plane 1608 that extends along the second surface 608.

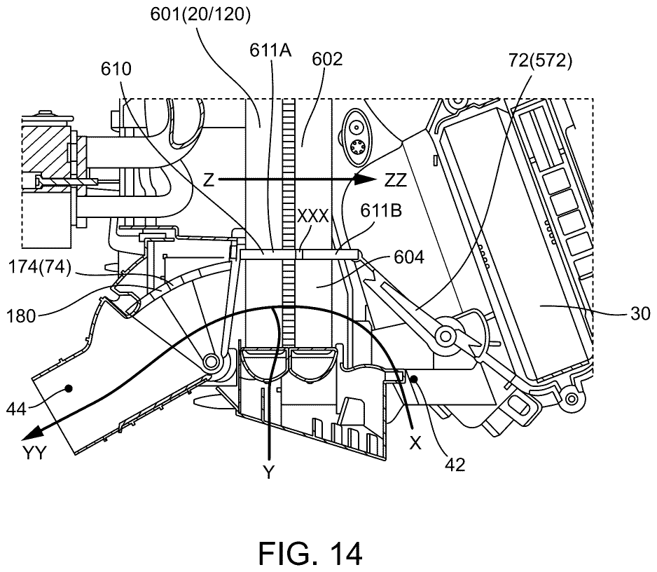

In some embodiments, the divider 610 extends from the first surface 606 and to the second surface 608 either entirely between the first and second surfaces 606, 608, or as described above in some embodiments, between the first and second surfaces 606, 608 with the small gap XXX disposed within the body (depicted in FIG. 14). In some embodiments, the gap XXX does not exist and therefore would not be seen in the image of FIG. 14. The gap XXX is preferably positioned at a center of the body—i.e. with the center of the gap XXX at one half of the overall width of the body 609 between the first and second surfaces 606, 608. In this embodiment, the two pieces 611A, 611B that are both assembled within the body 609 to form the divider 610 may be the same. Alternatively, the divider could be designed such that the gap XXX is positioned offset from the center of the center of the body, such as closer to the second surface 608 than the first surface 606 and in this embodiment, the two pieces 611A, 611B that form the divider 610 would be different (e.g. the lengths of the fingers 613A, 613B would be different in the two pieces) to establish a different position of the gap XXX from the center The construction of the divider 610 is further discussed below.

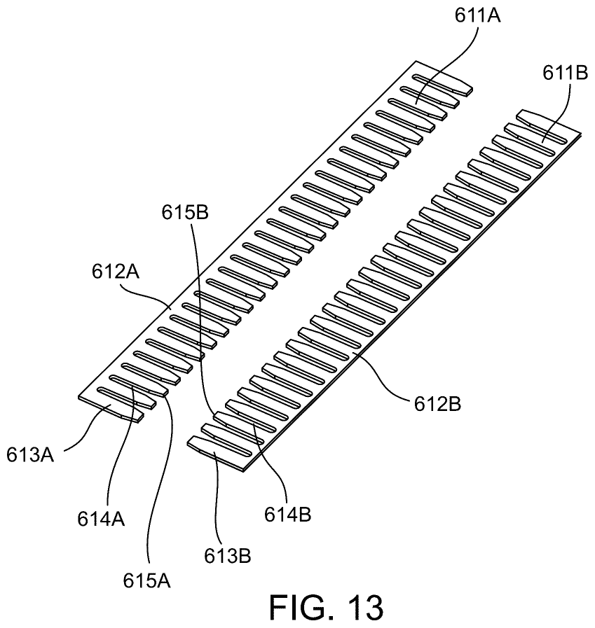

In some embodiments, an outer surface of the divider 610 ends (the outer edge of the elongate portion 612A, 612B, discussed below) at one or both of planes 1606, 1608 through the respective first and second surfaces 606, 608. In other embodiments, the elongate portion 612A, 612B of the divider 610 extends slightly outside of the body, and outside of the planes 1606, 1608 (such as about 5 mm, or about 2.5 mm, or within a range of about 5 mm to 0 mm). This embodiment may be preferred for ease of manufacturing purposes to allow an outer elongate portion of the divider (e.g. 612A, 612B—FIG. 13) to be supported during assembly as the fingers 613A, 613B extend into the body 609 of the heat exchanger 601 and as the divider is finally positioned (either with the tip portions 615A, 615B contacting each other, or in close proximity to each other to establish the final gap XXX). This embodiment may also be beneficial to require the air to flow out of the body 609 and for a certain distance (the distance that the elongate portion 612A, 612B extends outside of the respective plane 1606, 1608) to prevent the air leaving the body from flowing directly into the opposite portion (602, 604) of the body 609 immediately after leaving the body 609.

In embodiments where the gap XXX is provided, the gap XXX is provided for one or more functional purposes. The gap XXX allows liquid flow (due to condensation of the air within the body 609) to flow downwardly within the body due to gravity to allow the liquid that is within the body to flow out of the first portion 602 and into the second portion 604 through the gap XXX and then flow out of the heat exchanger from the second portion 604 to a drain that is disposed below the heat exchanger 601. The gap XXX is also provided to assist with manufacturing, in that it is not required or expected that the tip portions 615A, 615B contact each other after the two divider pieces 611A, 611B are installed within the body 609.

The divider 610 is formed from two pieces (e.g. 611A, 611B) that are both positioned within the body to establish the divider 610. As discussed above, in a preferred embodiment, both pieces 611A, 611B are preferably construed in the same manner and with the size and shape (i.e. they are identical before installation into the body). Alternatively—such as when a gap XXX is provided and it is desired to offset the gap away from the center of the body 609 (such as closer to the second surface 608) the pieces 611A, 611B may be formed differently. Each piece includes an elongate portion 612A, 612B that extends across the entire length or substantially the entire length of the respective piece, and a plurality of fingers 613A, 613B that extend from the respective elongate portion 612A, 612B. The elongate portion and the fingers establish a structure that is similar to a comb. The elongate portion and the fingers are each preferably constructed such that their opposite top and bottom surfaces extend along parallel planes.

The plurality of fingers 613A, 613B are each arranged with a consistent spacing between adjacent fingers, with a space 614A provided between adjacent fingers 613A and a space 614B provided between adjacent fingers 613B. Alternatively, when the vertical conduits 620 within the heat exchanger body 609 are not uniformly distributed along the horizontal cross-section of the body, the placement of the fingers and the size of the spaces may vary to adapt to the distribution of the vertical conduits 620.

In some embodiments, a tip portion 615A, 615B of each finger 613A, 613B may have a width that is smaller than a width of the respective finger between the tip portion and the elongate portion. The width through the tip portion 615A, 615B may reduce as the finger extends to the end edge of the finger. The spaces 614A, 614B provide space for the vertical conduits 620 (FIG. 11A) within the heat exchanger (for refrigerant or coolant flow) to extend when the two divider pieces 611A, 611B extend through the body 609 of the heat exchanger.

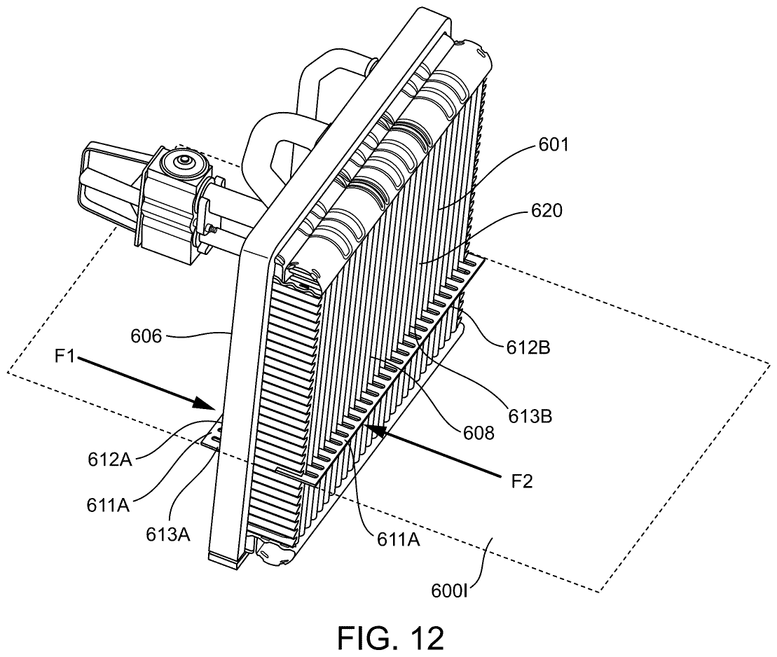

As best understood with reference to FIGS. 12 and 13, the pieces 611A, 611B are installed within the body 609 of the heat exchanger from opposite sides, such that the fingers 613A of the first piece 611A extends through the first surface 606 such that each vertical conduit 620 is aligned with a space 614A within the piece, and the piece 611A is pushed into the body 609 of the heat exchanger (arrow F1) until the elongate portion 612A contacts the vertical conduits 620 at the first surface 606. The first piece 611A is aligned along a plane 6001 that is perpendicular to the first surface 606 and is positioned at the desired border between the first and second sections 602, 604 of the heat exchanger 601. The second piece 611B is aligned along the plane 6001 and is aligned such that each space 614B is aligned with a vertical conduit 620 such that the fingers 613B extend into the body 609, and is pushed into the body (arrow F2) until the elongate portion 612B contacts the vertical conduits 620. As discussed above, in some embodiments, the tip portions 615A, 615B may be proximate to each other such that they contact each other when the two pieces are fully inserted into the body, or be proximate to each other such that the tip portions may form a gap XXX discussed above. After the pieces 611A, 611B are properly installed, they are fixed to the heat exchanger, such as by brazing.

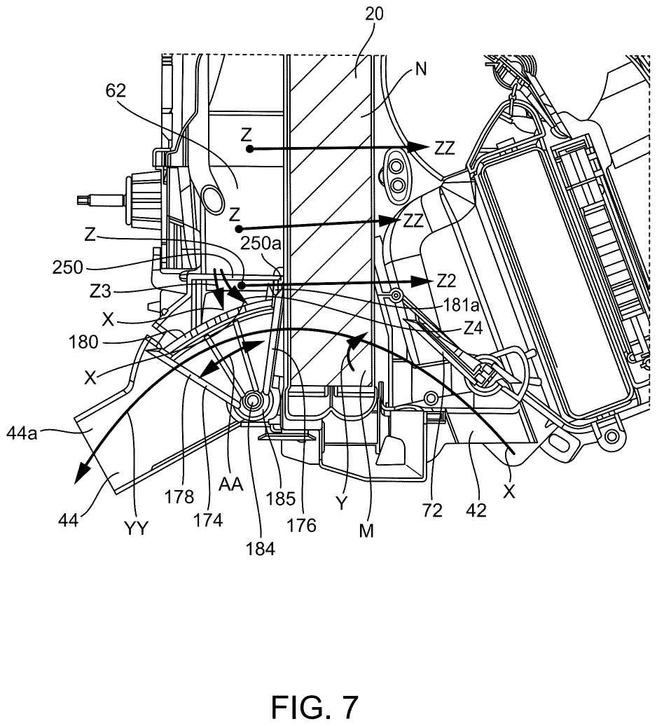

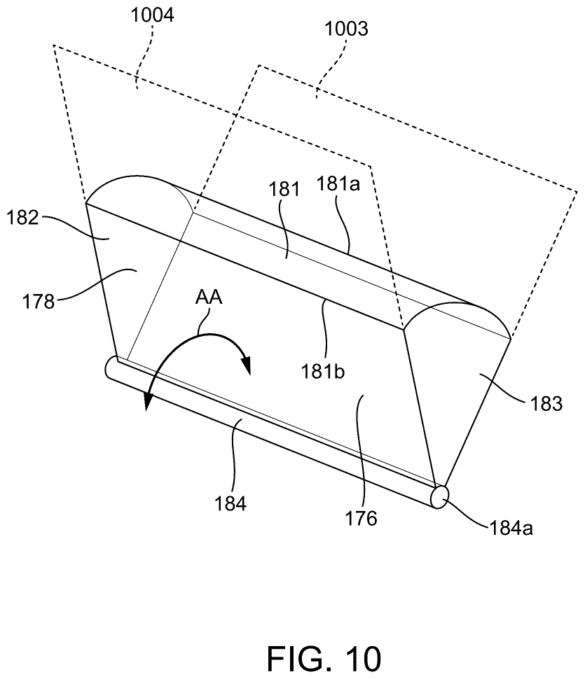

Turning now to FIGS. 7-10, the HVAC system 100 is provided with a preferred outlet valve 174, which is within the outlet 44 of the relief air flow path, which is a barrel valve. The barrel valve 174 may be provided instead of the flapper valve 74 (second valve) that is depicted in FIGS. 2-6. The barrel valve 174 includes an inlet aperture 176, and outlet aperture 178, and a circumferential blocking portion (or a shroud) 180 that extends between the inlet and outlet apertures 176, 178. With reference to FIG. 10, the inlet aperture 176 is aligned along plane 1003 and the outlet aperture 178 is aligned along plane 1004. The circumferential blocking portion 180 establishes a flow path AA within the barrel valve 174 between the inlet and outlet apertures 176, 178, and the blocking portion 180 blocks air flow into the air flow path AA other than from the inlet and outlet apertures 176, 178.

The blocking portion 180 may include a curved circumferential portion 181 that extends between top edges of the inlet and outlet apertures 176, 178. The circumferential portion 181 may be a continuous curve (i.e. the same radius) along the entire length of the blocking portion between the inlet and outlet apertures 176, 178. In other embodiments, a portion of the circumferential portion 181 may be a continuous curve, while another portion may be at a different continuous curve, and/or a discontinuous curve. The geometry of the circumferential portion 181 may be provided to allow the valve 174 to freely move between the first and second positions within the outlet plenum 44 (discussed below) while maximizing the cross-sectional flow area within the flow path AA. One of ordinary skill in the art with a thorough review of the specification would be able to appropriately size and shape the blocking portion 180 (both the circumferential portion 181 and the side portions 182, 183 as discussed below) in view of the needed range of travel of the valve 174 and with respect to the space available within the outlet portion 44 of relief air path, just below the heat exchanger 20 inlet.

The blocking portion 180 includes a first and second side portions 182, 183 that extend inwardly from the circumferential portion 181 toward a center hub 184 and establish the side walls of the barrel valve 174. In some embodiments, the side portions 182, 183 extend toward a center hub 184 that receives a shaft 184a therethrough, with rotation of the shaft 184 causing rotation of the valve 174. The side portions 182, 183 prevent flow from extending therethrough and into the air flow path AA. The side portions 182, 183 may be parallel to each other and spaced apart a distance that is just less than a width of the outlet plenum 44 (with the width being the distance into and out of the page in the view of FIGS. 6 and 7). The barrel valve 174 may be sized such that the side portions 182, 183 are closely proximate to, in in some embodiments in contact with, the side walls (44a, 44b) of the outlet plenum 44.

Like the valve 74 discussed above, the outlet (second) valve 174 is positionable in a first position (i.e. the third position as identified in the as-filed claims with this specification) that allows air flow into the inlet aperture 176, through the air flow path AA, and out the outlet aperture 178 and into the outlet relief flow path 44. The barrel valve 174 is positioned such that when in the first position (FIG. 7) air that enters into the inlet aperture 176 from the heat exchanger 20 (air flow path Y—FIG. 7), and specifically the portion of the heat exchanger 20 that is aligned with the inlet aperture 176 (M—FIG. 7) flows through the flow path AA and leaves the outlet aperture 178. The air that flows through the outlet aperture continues to flow through the outlet portion 44, as discussed above.

When the valve 174 is in the first position (FIG. 7), air that approaches the inlet plenum 62 of the heat exchanger 20 (which flows from an air inlet and a fan within the HVAC—upstream of the heat exchanger in the typical air flow path through the HVAC system—and initially flows in a direction out of the page that FIG. 7 is printed on) is blocked by the blocking portion 180 from flowing into the outlet portion 44 or the air relief system, as schematically depicted as flow Z3 in FIG. 7. Air flow that approaches the inlet plenum 62 of the heat exchanger 20 is also blocked by the blocking portion 180 from flowing into the portion of the heat exchanger 20 that is aligned with the inlet opening 176 of the valve 174 (portion M), as can be understood with reference to FIGS. 7-8.

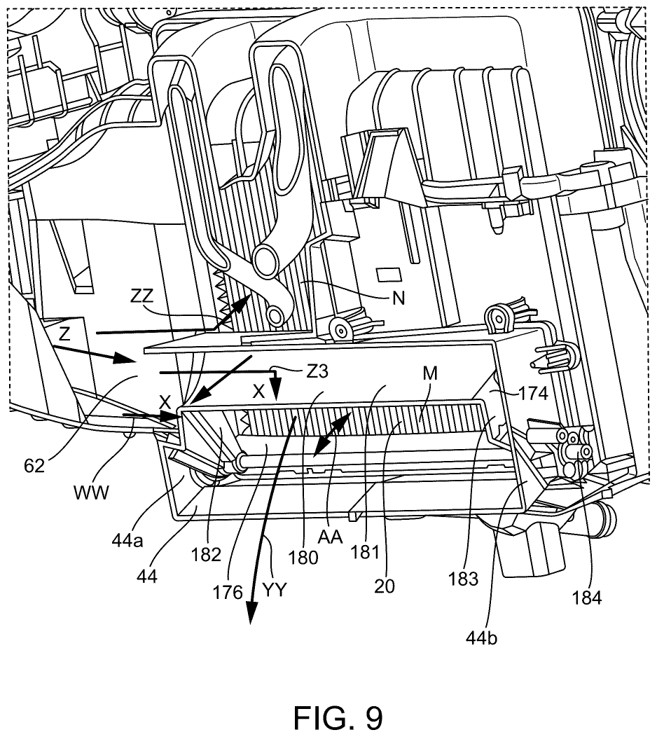

In some embodiments, the valve 174 is aligned within the HVAC system such some air enters that an inlet plenum 62 proximate to the barrel valve 174 approaches one or the other of the side portions 182, 183 of the barrel valve 174. The presence of the side portions 182, 183 prevents air from entering into the air flow path AA within the valve 174 from the sides (as depicted with arrow WW on FIG. 9, which flows from the inlet plenum 62 but is blocked by the side portion 182), as well as the circumferential portion 181 prevents air entering therethrough (flow Z3) as discussed above.

When the barrel valve 174 is in the second position (FIG. 8), the barrel valve 174 has rotated (or moved in embodiments where the valve does not purely rotate) such that the circumferential portion 181 becomes aligned within the outlet portion 44 to block air flow that flows through the heat exchanger 20 (portion M) and into the air flow path AA from continuing to flow through the outlet portion 44, as schematically depicted by air flow path YY being blocked by the circumferential portion 181. As understood with respect to FIG. 8, in the second position, the inlet aperture 176 rotates away from the heat exchanger 20 and becomes aligned with the inlet plenum 62 proximate to the inlet of the heat exchanger 20, such that air from the inlet plenum 62 can flow into the air flow path AA (air flow Z3—FIG. 8), but the circumferential portion 181 blocks the air Z3 from flowing therepast and through the outlet portion 44.

As also shown in FIG. 8, when the valve 174 is in the second position air from the plenum 62 can flow into the portion M of the heat exchanger 20 that is aligned with the inlet aperture 176 when the barrel valve 174 is in the first position (shown schematically as flow Z4 in FIG. 8.

In some embodiments, the HVAC housing may include a support 250 that extends through the air inlet plenum 62. The support 250 is provided to include an edge portion 250a that a top edge 181a of the circumferential portion 181 that forms the top edge of the inlet opening 176 rests against when the barrel valve 174 is in the first position (FIG. 7) to ensure that the barrel valve 174 is properly maintained in the first position. The edges of the first and second walls 182, 183 and the opposite edge 182b of the circumferential portion 181 contact the floor (44c) of the relief outlet 44 when the barrel valve 174 has reached the second position, as show in FIG. 8. FIG. 7 depicts that in some embodiments, there is a space between the circumferential portion 181 and the support to allow some air Z from the plenum 62 to flow through the heat exchanger below the support 250 (schematic flow Z2—FIG. 7).

In some embodiments, the HVAC system is controlled such that the inlet (first) valve 42 is in the closed position (i.e. preventing flow through the inlet portion 44) so that the air from the inlet plenum 62 that flows through the portion of the heat exchanger 20 (FIG. 8, flow path Z4 (although FIG. 8 shows the valve 42 open, and not shut as described herein)) that leads to the inlet plenum 42 is blocked from flowing into the inlet plenum 42 and instead flows into the HVAC assembly for direction therewithin as controlled by the HVAC controller 1009.

In some embodiments, the first valve 74, which is within the inlet 42 of the relief air flow path, may be formed as a barrel valve that is exactly like or similar to the barrel valve 174 that is in the relief outlet 44 (discussed above). The term “substantially the same” includes the exact same construction, as well as a construction with the same features but somewhat different sizes and geometries as necessitated by the different environments that the first and second valves are disposed in with in the relief system. In this embodiment, the barrel valve is positioned such that air flow inlets and outlets (like 176, 178) allow flow through an internal air flow path (like AA) to allow air from the passenger compartment to reach the heat exchanger 20 (at the position M). When the first valve 72 is in the second position, the valve 72 is moved (in some embodiments rotated) such that the blocking portion (180, and specifically a portion that is the same as or similar to the circumferential portion 181) is disposed within the air inlet 42 to prevent air to flow past the blocking portion 180. The first valve 74 (when a barrel valve) is controlled by the HVAC controller 1009.

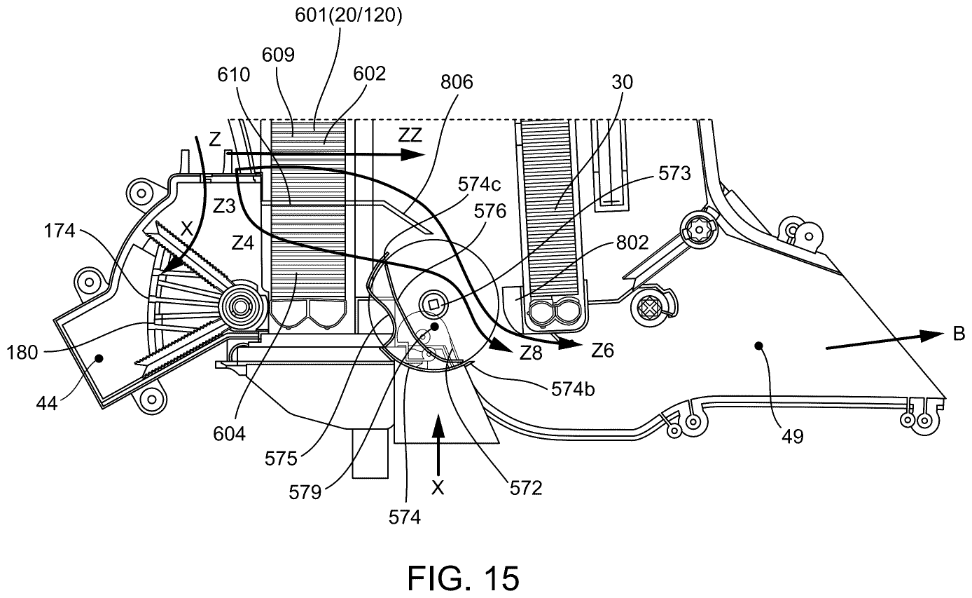

Turning now to FIGS. 15-17, a modified HVAC system is provided with a preferred inlet valve 572, which can replace the inlet valve 72 discussed in the embodiments above. The inlet valve 572 is provided for HVAC systems where it is desired to allow for air flow from the heat exchanger (out the second surface 608) to flow to the outlet 49 within the HVAC housing 10 that flows to the floor vents within the vehicle or in some embodiments to vents within a second or third row of the vehicle (flow B). The HVAC housing 10 may include one or more air features that are aligned with the inlet valve 572 to direct the air as desired or prevent air flow as desired.

With reference to FIG. 15, the HVAC system is aligned for operation that prevents air flow X from the passenger space through the second portion 604 of the heat exchanger 20/120 (601) and into the second air outlet 44. Air is allowed to flow from the heat exchanger (first portion 602) and toward the outlet B (air flow Z6), which flows to the outlet B but bypasses the heating element 30, and in some embodiments, air also can flow from the second portion 604 of the heat exchanger (if the valve 174 is aligned to allow such flow—i.e. as the valve 174 is disposed in FIG. 15).

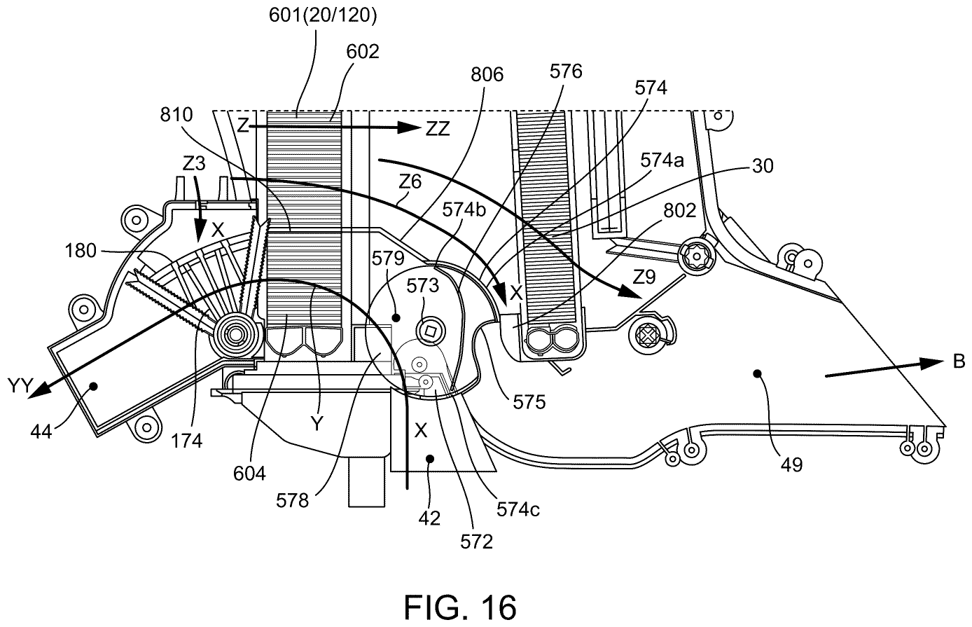

With reference to FIG. 16, the HVAC system is aligned for operation that allows air flow X from the passenger compartment to the second portion 604 of the heat exchanger (flow Y) and out of the HVAC system to the second outlet 44 (flow YY). Air is prevented from flowing from the heat exchanger and directly to the air outlet B (air flow Z6), which would flow to the air outlet B while bypassing the heating element 30.

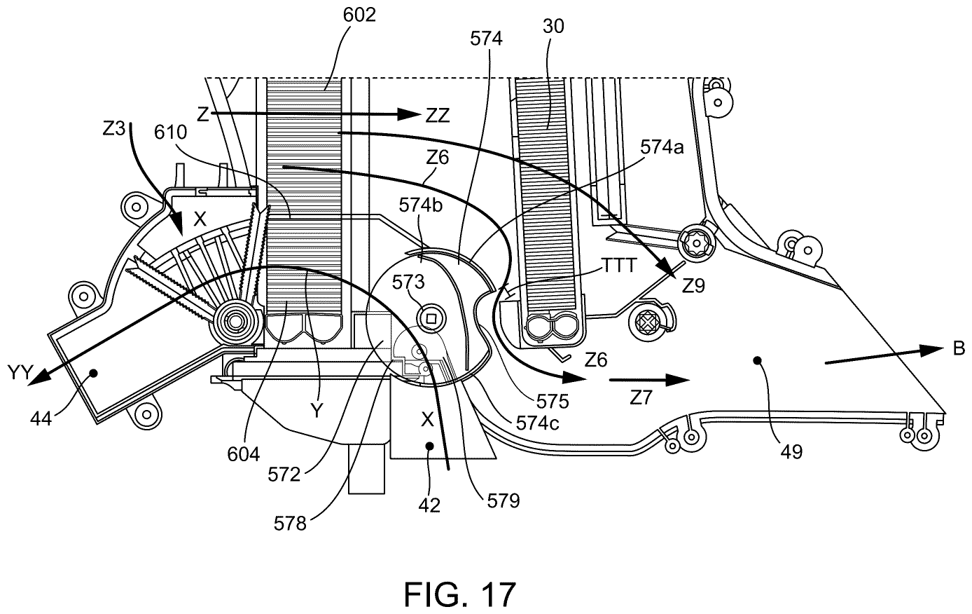

With reference to FIG. 17, the HVAC system is aligned for operation that allows air flow X from the passenger compartment to the second portion 604 of the heat exchanger (flow Y) and out of the HVAC system to the second outlet (flow YY). Air is also allowed to flow from the heat exchanger first portion 602 and toward the air outlet B while bypassing the heating element 30 (air flows Z6, Z7).

The inlet valve 572 preferably forms a cylindrical space 579 (i.e. a cylindrical geometry—although some of the outer circumference of the cylindrical geometry does not have a physical surface thereon) and may have opposite end faces 578, with one of the opposite end faces depicted in cross-sectional views of FIGS. 15-17 with a similar opposite end face provided on the opposite side of the valve, which would be the same size and shape as the end face 578 and would be parallel to the end face 578 but would be positioned outside of the paper that FIGS. 15-17 are printed on. The end faces 578 support a center shaft 573, which is rotated to rotate the position of the inlet valve 572 into the desired position and supports the opposite end faces 578.

A blocking portion 574 is provided and extends along a portion of the outer circumference of the cylinder. The blocking portion 574 includes an outer face 574a and an inner wall 576 that extends between two ends of the outer face 574a and extends within the volume of the cylinder formed by the valve. The outer face 574a extends between opposite ends 574b, 574c that each are disposed upon an outer projection of the cylindrical space 579 defined by the valve 572. The inner wall 576 extends through the cylindrical space 579 and is disposed inboard of the outer face 574a and is disposed entirely on one side of the center shaft 573 as depicted in the figures. The inner wall 576 extends between the opposite ends 574b, 574c (at the outer surface of the cylindrical space 579.

The inlet valve 572 is configured to allow air flow through the cylindrical space 579 between the two end faces 578, such that air flows past the center shaft 573 and as guided by the inner wall 576. FIGS. 16 and 17 depict air flow X that flows through the cylindrical space 579 from the passenger compartment (air inlet 42) and into the second portion 604 of the heat exchanger 20/120. FIG. 15 depicts air flows Z6 and Z8 that flows from the heat exchanger 20/120 (Z6 from the first portion 602, Z8 from the second portion 604) through the cylindrical space 579 and toward the outlet portion 49 of the housing 10.

As depicted in the figures, the position of the inlet valve 572, and specifically the blocking portion 574 with respect to the surrounding portions of the housing 10 controls the allowed air flow. As depicted in FIG. 15, the blocking portion 574 is aligned with the air inlet 42 from the passenger compartment and therefore blocks air flow (flow X) from the air inlet 42 to the heat exchanger 20/120. The blocking portion is rotated away from wall section 802 upon the housing 10 that is proximate to the second heat exchanger 30 (or 130 in other embodiments herein) and is rotated way from a second wall section 806 that extends from contact with or proximate to the second surface 608 of the heat exchanger to allow flow Z6 to flow through the cylindrical space 579. In embodiments where the divider 610 is provided, discussed above, the second surface 608 extends from contact with or proximate to the divider 610. Air that flows over the wall section 806 and the divider 610 (when provided) (flow Z6) from the first portion 602 of the heat exchanger flows through the cylindrical space 579 and air that flows below the divider (610, when provided) and the wall section 806 (flow Z8) from the second portion 604 (when the second valve 174 is configured to allow flow) flows through the cylindrical space 579. As depicted in FIG. 16, a first end 574b of the blocking portion 574 is in contact with or very close to an end of the second wall section 806 and the blocking surface extends to (either in contact with or in very close proximity to) the wall section 802 to prevent air flow between the blocking portion 574 and the wall section 802, which prevents air from the first portion 802 of the heat exchanger (and flow from the second portion 804) from flowing toward the outlet portion B while bypassing the heating element 30.

As depicted in FIG. 17, the blocking portion 574 includes a recessed portion 575, where the outer surface of the blocking portion 574 recesses into the cylindrical profile 579 of the valve. In some embodiments, the recessed portion 575 is disposed between the first and second ends 574b, 574c of the blocking portion 574 and does not reach either of the first or second ends 574b, 574c.

In the position of the valve 572 depicted in FIG. 17, the recessed portion 575 is aligned with the wall section 802, which provides a space TTT between the blocking portion 574 and the wall 802, which allows air flow Z6 from the first portion 602 of the heat exchanger 20/120 through space TTT and toward the outlet B, thereby allowing air from the first portion 602 of the heat exchanger 20/120 to bypass the heating element 30.

In some embodiments, the blocking portion 574 extends between the first and second ends 578 of the first valve and the cross-section of the blocking portion 574 is the same along the entire width of the first valve.

The valve 572 can be controlled by the HVAC controller 1009 (discussed above) to position the valve 572 into the desired position as discussed above. As discussed above, the controller 1009 further can operate the second valve 74, 174 in conjunction with the valve 572 to achieve the desired air flow through the HVAC system.

In some embodiments the HVAC systems disclosed herein (including one or both of the blocking portion 610 and the valve 572 discussed above) can be operated according to the following method. In some embodiments, the inlet housing 200 may include a third valve 820 (FIG. 1, schematic) that is provided within or outside of the inlet housing 200 and in conjunction with a screen that forms with the passenger compartment air inlet 202. The third valve 820 is movable from a first position (as schematically shown, with the valve 820 disposed outside and across the air screen to block the air screen) such that the surfaces of the valve 820 are disposed above the screen to prevent air flow through the screen of the inlet. The valve 820 is movable/rotatable in a direction MM to a position where a substantial portion of the screen 202 is exposed to allow air flow rough the screen 202 (not shown, the portions of the valve 820 would rotate away from a portion of the curved screen 202 to expose the screen—to away from the screen if the valve 820 is positioned within the housing 200 and below the screen 202). The valve 820 can be rotated in the direction NN to cover more of the screen 202 but still allow some flow through the screen, with the third valve 820 being in an intermediate position (some screen covered, some screen exposed) to allow a throttled amount of flow into the housing 200.

The controller 1009 may control the position of the third valve 820 (along with the positions of the valves 72/572 and 74/174) to control the operation of the HVAC system as desired by the user and based upon the environment outside and inside of the vehicle and the speed of the vehicle. When the third valve 820 is opened, passenger compartment air is drawn into the housing 200 through the screen 202 and via the blower (within housing 205) that urges the air to the heat exchanger 20/120. When the third valve 820 is closed, no air from the passenger compartment is drawn through the screen 202 and into the housing, and instead air is drawn into the housing 200 from outside of the vehicle (inlet 201) when a valve (not shown) that exposes or blocks the inlet 201 is in an open or throttled open position. When the third valve 820 is in an intermediate position, some air is drawn into the housing 200 through the screen 202 (but less than a mass flow rate of air when the third valve 820 is fully open).

The controller 1009 may receive several signals that determine the mode of operation of the HVAC system (sensors to identify each signal are depicted schematically in FIG. 1), with the controller receiving signals from respective sensors that are configured and positioned to reflect parameters of the vehicle and the environment inside and outside of the vehicle. A sensor 830 may be provided that determines the speed of the vehicle as well as the direction of the transmission (forward, reverse). A sensor 840 may be provided that determines the ambient temperature outside of the vehicle. A sensor 850 may be provided that determines the ambient temperature within the vehicle (and at a specific position within the passenger compartment (e.g. below the steering wheel, or proximate to the windshield, etc.) A sensor 850 may be provided that determines the relative humidity within the passenger compartment and at a specific location (e.g. below the steering wheel, or proximate to the windshield, etc.).

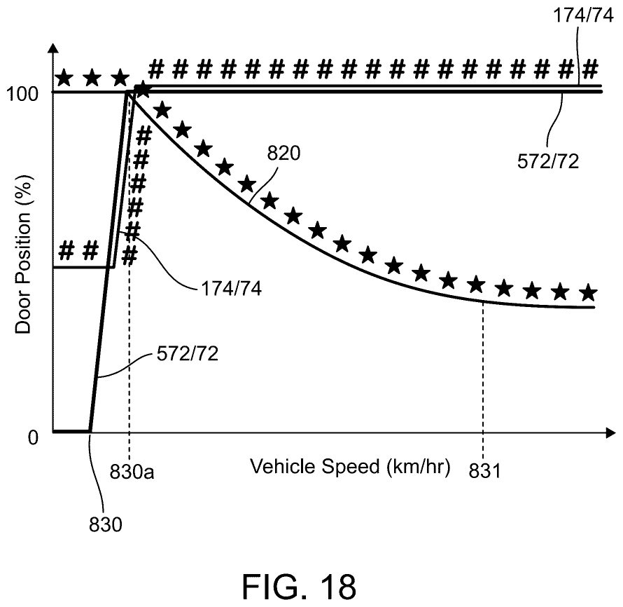

The controller 1009 controls the positions of the valve 72/572, the second valve 74/174, and the third valve 820 (as well as in some embodiments a valve (not shown) that controls the flow from outside of the vehicle into the air inlet housing 200—via flow 201) based upon a desired mode of operation of the HVAC system (typically selected by an occupant of the vehicle, driver or passenger) and in view of the signals received from the sensors. Wherein the method is operated when the outside ambient temperature is low to require heat be produced either for heating the passenger compartment or for defrost or deicing (signals 840 vs. 850). In this situation and as depicted in FIG. 18, the HVAC system may be operated to cause passenger compartment air to flow through the second portion 604 of the heat exchanger 20/120 (air flow X to Y to YY) with the valve 572 in the second position (FIG. 16) and the valve 74/174 positioned to allow air flow from the heat exchanger and out of the second outlet 44 (or in embodiments were the first valve is valve 72 (FIGS. 2-6 that can either be open or shut) the controller operates the first valve 72 to be open or shut (shut when in the operational environment of FIG. 15, open for the operational environment of FIG. 16). Specifically, when it is desired to provide passenger compartment heat via the air flow X, Y, YY through the second portion 604 of the heat exchanger to add heat from the heat exchanger to the air that flows from the blower and into the first portion 602 of the heat exchanger (as discussed herein), the controller 1009 determines whether the vehicle is moving in the forward direction (sensor 830). If the vehicle is moving in the forward direction (and in some embodiments moving above a threshold speed (speed 830, FIG. 18, e.g. 20 mph, 30 mph etc. or faster—or a different speed that would be identified by one of ordinary skill in the art with a thorough review and understanding of this specification and with routine optimization)) the controller 1009 causes the position of valve 572 to be in the second position (FIG. 16) (or the valve 72 to be opened—FIGS. 4, 6-8) and the valve 74/174 to allow air flow from the passenger compartment through the second portion 604 of the heat exchanger 20/120 and to the air outlet 44 (FIGS. 4, 6-7). The controller operates in this manner because with sufficient motion of the vehicle in the forward direction, a suction is generated at the second outlet 44, which tends to urge air to flow through the path X, Y, YY as discussed above. During this step, the controller maintains the third valve in a partially closed (mid position) (moves in direction NN from the fully open position) to reduce passenger compartment air flow into the housing 200 below the flow rate when the valve 820 is in the open position (FIG. 18). Some of the air that enters the housing 200 is from outside air (flow path 201), which is most often at a lower humidity than the air within the passenger compartment, which when that air (after leaving the heat exchanger 20/120 (flow Z to ZZ)) is directed toward the windshield tends to remove the accumulated moisture from the windshield. Simultaneous air flow X, Y, YY through the second portion 604 of the heat exchanger 20/120 allows a portion of the heat from the passenger compartment air that flows through the second portion 604 to be transferred to the refrigerant/coolant and then be transferred to the air (Z-ZZ) that flows through the first portion 602, thereby reducing the need to operate the heating element (30) and thereby reducing the electrical usage of the HVAC system for defog defrost operations when the vehicle is moving (i.e. heat needed to increase the temperature of the colder outside air entering the HVAC system).

If the controller 1009 identifies that the vehicle is not moving in the forward direction (or is moving below a threshold speed 1830) the controller 1009 causes the valve 572 to move to the first position (FIG. 15) (for valve 72 to the closed position (FIG. 3, 5)) to prevent flow from the passenger compartment and into the second portion 604 of the heat exchanger 20/120, and the controller moves the third valve 820 to allow/increase the amount of passenger compartment air flow into the air intake housing 200 (rotates valve into the open position—direction MM, see FIG. 18). In some embodiments the third valve 820 is fully open when below the threshold speed (1830—FIG. 18). In this circumstance, because the vehicle is not moving, there is no suction formed at the outlet 44 and therefore the flow of passenger compartment air through the second portion 604 of the heat exchanger 20/120 significantly drops. Also, because there is no cold air flowing across the windshield caused by vehicle movement the amount of heat that needs to be provided to the windshield reduces. In this situation, the recirc air flow (into the air intake housing 200) itself can provide for the air (Z to ZZ) for defogging/defrost. In some embodiments the second valve 74/174 is maintained in position to allow flow from the second portion 604 to the second outlet 44.

In some embodiments as depicted in FIG. 18, when the speed is above the threshold speed (1830) the third valve further closed with increasing speed, but at a second increased predetermined speed (1831, FIG. 18) the third valve 820 is maintained at a constant mid-position. In some embodiments when the vehicle is idle or moving below the threshold speed 1830, and when the second valve 174 is provided the controller 1009 maintains the second valve 174 in an intermediate position (between the positions of FIGS. 7 and 8) to allow some flow air flow (Z) to flow through the second portion 604 of the heat exchanger (from the first surface 606 through the body 609 and out the second surface 608).

FIG. 18 depicts some slope in the position of valves 72/572 and 74/174 when the velocity reaches the threshold velocity 1830, with the valves fully open when reaching a velocity 1830a. This is only for visual purposes for the reader, and the valves will be fully open is at or above the threshold speed 1830 and fully closed when below the threshold speed (i.e. the speed 1830a is the same as speed 1830). One of ordinary skill in the art will readily understand that this includes a situation where the valves both receive a signal to open when the speed is at the threshold speed, but it may take the valves a set period of time to open upon receipt of the signal to open and therefore due to the acceleration the vehicle may be traveling at a speed above the threshold speed (e.g. 1830a) when the valves are open.

The term “about” is specifically defined herein to include a range that includes the reference value and plus or minus 5% of the reference value. The term “substantially the same” is when the item under comparison is within 5% of the aspect of the reference value of the item.

The computing elements or functions, such as the HVAC controller or the vehicle controller disclosed herein may include a processor and a memory storing computer-readable instructions executable by the processor. In some embodiments, the processor is a hardware processor configured to perform a predefined set of basic operations in response to receiving a corresponding basic instruction selected from a predefined native instruction set of codes. Each of the modules defined herein may include a corresponding set of machine codes selected from the native instruction set, and which may be stored in the memory. Embodiments can be implemented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, optical disc, memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described embodiments can also be stored on the machine-readable medium. Software running from the machine-readable medium can interface with circuitry to perform the described tasks. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Naturally, in view of the teachings and disclosures herein, persons having ordinary skill in the art may appreciate that alternate designs and/or embodiments of the invention may be possible (e.g., with substitution of one or more components for others, with alternate configurations of components, etc.). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The specification is readily understood with reference to the following Numbered Paragraphs:

Numbered Paragraph 1: A HVAC system for a vehicle, comprising:
a heat exchanger configured to be disposed within a vehicle, the heat exchanger comprises a first surface and an opposite second surface, wherein a body of the heat exchanger is disposed between the first and second surfaces, wherein the body includes a first portion and a second portion that is different from the first portion;
a first air inlet configured, when installed within the vehicle, to receive air that flows therein from a blower through the first surface, wherein the blower can receive either air from a passenger compartment of the vehicle and/or air from outside of the vehicle, wherein air is directed to flow from the blower into a first portion of the heat exchanger;
a second air inlet different from the first air inlet, the second air inlet disposed to direct air received therethrough into the second portion of the heat exchanger, the second air inlet configured to receive air that flows therein from within a passenger compartment of the vehicle;
the heat exchanger is disposed to direct air from the first air inlet through the first portion of the heat exchanger and the heat exchanger is disposed to direct air from the second air inlet through the second portion of the heat exchanger simultaneously;
a divider positioned across the heat exchanger at a position that establishes a boundary between the first and second positions of the heat exchanger, wherein the boundary prevents or substantially prevents air flowing through the first portion of the heat exchanger from flowing into the second portion of the heat exchanger within a body of the heat exchanger and the boundary prevents or substantially prevents air flowing through the second portion of the heat exchanger from flowing into the first portion of the heat exchanger within the body of the heat exchanger.

Numbered Paragraph 2: The HVAC system of Numbered Paragraph 1, wherein the first portion of the heat exchanger is vertically above the second portion of the heat exchanger.

Numbered Paragraph 3: The HVAC system of either of Numbered Paragraph 1 or 2, wherein air from the first inlet flows into the heat exchanger through the first surface and out of the heat exchanger through the second surface, and air from the second air inlet flows into the heat exchanger through the second surface and out of the heat exchanger through the first surface;
wherein the divider has a first member that extends across the first surface, and a second member that extends across the second surface.

Numbered Paragraph 4: The HVAC system of Numbered Paragraph 3, wherein the boundary extends across the heat exchanger from the first surface to the second surface.

Numbered Paragraph 5: The HVAC system of either of Numbered Paragraphs 3 or 4, wherein the boundary has a break therein along a center portion of the heat exchanger, wherein a width of the break is less than about 5% of an overall width of the heat exchanger between the first and second surfaces.

Numbered Paragraph 6: The HVAC system of Numbered Paragraph 5, wherein the break is configured to allow liquid to flow downwardly therethrough from the first portion of the heat exchanger to the second portion of the heat exchanger, wherein the liquid that flows through the break ultimately flows to a drain disposed below the heat exchanger.

Numbered Paragraph 7: The HVAC system of either of Numbered Paragraph 5 or 6, wherein the break is aligned at a center of the heat exchanger.

Numbered Paragraph 8: The HVAC system of any one of Numbered Paragraphs 3-7, wherein the first member of the divider comprises an elongate portion that extends across substantially an entire length of the first member and a plurality of fingers that extend outwardly from the elongate portion, wherein adjacent fingers of the plurality of fingers establish a space therebetween, and the second member comprises an elongate portion that extends across substantially an entire length of the second member and a plurality of fingers that extend outwardly from the elongate portion, wherein adjacent fingers of the plurality of fingers establish a space therebetween.

Numbered Paragraph 9: The HVAC system of Numbered Paragraph 8, wherein when installed, the elongate portion and fingers of the first member are disposed along a plane and the elongate portion and fingers of the second member are also disposed along the plane.

Numbered Paragraph 10: The HVAC system of either of Numbered Paragraph 8 or 9, wherein when installed, an outer tip of each finger of the first member extends to a position that is proximate to an outer tip of a respective finger of the second member.

Numbered Paragraph 11: The HVAC system of Numbered Paragraph 10, wherein the outer tip of each finger of the first member and the outer tip of each finger of the second member is narrower than a width of the respective finger inboard of the outer tip.

Numbered Paragraph 12: The HVAC system of Numbered Paragraph 11, wherein a width of each respective finger increases from a width at the outer tip to a constant width that is proximate to the outer tip, wherein the constant width extends for a remaining portion of each respective finger.

Numbered Paragraph 13: The HVAC system of any one of Numbered Paragraphs 8-12, wherein when installed an outer edge of the elongate portion of the first member extends along the first surface, and when installed an outer edge of the elongate portion of the second member extends along the second surface of the heat exchanger.

Numbered Paragraph 14: The HVAC system of Numbered Paragraph 13, wherein when installed the outer edge of the elongate portion of the first member extends either along a plane along the first surface of the heat exchanger, or just slightly outside of the plane along the first surface of the first portion of the heat exchanger, and
when installed the outer edge of the elongate portion of the second member extends either along a plane along the second surface of the heat exchanger, or just slightly outside of the plane along the second surface of the heat exchanger.

Numbered Paragraph 15: A HVAC system for a vehicle, comprising:
a heat exchanger configured to be disposed within a vehicle, the heat exchanger comprises a first surface and an opposite second surface, wherein a body of the heat exchanger is disposed between the first and second surfaces, wherein the body includes a first portion and a second portion that is different from the first portion;
a first air inlet configured, when installed within the vehicle, to receive air that flows therein from a blower through the first surface, wherein the blower can receive either air from a passenger compartment of the vehicle and/or air from outside of the vehicle, wherein air is directed to flow from the blower through the first inlet and into the first portion of the heat exchanger;
a second air inlet different from the first air inlet, the second air inlet disposed to direct air received therethrough into the second portion of the heat exchanger, the second air inlet configured to receive air that flows therein from within a passenger compartment of the vehicle;
the heat exchanger is disposed to direct air from the first air inlet through the first portion of the heat exchanger and the heat exchanger is disposed to direct air from the second air inlet through the second portion of the heat exchanger simultaneously;
wherein the first air inlet is positioned to cause air flow through the heat exchanger at a first position within the heat exchanger that is vertically above a second position within the heat exchanger,
further comprising a first air outlet configured to receive air from the heat exchanger that flowed from the second air inlet and through the second portion of the heat exchanger, wherein the first air outlet is aligned to direct air that flows into the first air outlet to flow outside of the vehicle,
wherein the second air inlet comprises a first valve disposed therein, wherein the first valve is positionable in a first position to allow air to flow into the heat exchanger through the second air inlet, and a second position to prevent or substantially prevent air to flow into the heat exchanger through the second air inlet,
the first valve extends along a cylindrical profile with an outer circumference that extends along a length thereof between first and second ends, wherein a portion of the outer circumference includes a blocking portion to prevent air flow past the blocking portion and into an inner volume of the cylinder, and a portion of the outer circumference is not blocked to allow flow therethrough and into the inner volume.

Numbered Paragraph 16: The HVAC system of Numbered Paragraph 15, wherein the blocking portion further comprises an inner wall that extends therethrough along a path through an inner volume of the cylinder, wherein the inner wall extends between opposite ends disposed upon the outer circumference, wherein the path of the inner wall remains on one side of a center axis along an entire length of the path between the opposite ends.

Numbered Paragraph 17: The HVAC system of Numbered Paragraph 16, wherein the path extends between the first and second ends of the cylinder.

Numbered Paragraph 18: The HVAC system of either one of Numbered Paragraph 16 or 17, wherein the blocking portion comprises a first end that intersects with a first end of the inner surface and the blocking portion comprises a second end that intersects with a second end of the inner surface, wherein the blocking portion includes a second portion that is recessed inwardly of circumferential profile between the first and second ends of the blocking portion.

Numbered Paragraph 19: The HVAC system of any one of Numbered Paragraphs 15-18, further comprising a housing, wherein the first valve and the heat exchanger are supported within the housing;
wherein the housing establishes a first flow path from the blower to the first surface of the heat exchanger, a second flow path from the second surface and the first portion of the heat exchanger, a third flow path from a passenger compartment within the vehicle, through the first valve and into the second portion of the heat exchanger, and a fourth flow path from the first portion and the second surface of the heat exchanger that leads into the passenger compartment,
wherein the first valve is rotatably supported within the housing between three positions, a first position where the blocking portion is aligned with the third flow path to prevent air flow therethrough and into the second portion of the heat exchanger, a second position where the blocking portion is withdrawn from the third flow path such that air that approaches the first valve from the third flow path can flow into the inner volume of the cylinder and into the second portion of the heat exchanger but where the blocking portion corresponds with the housing to prevent air flow through the fourth flow path, and a third position where the blocking portion is withdrawn from the third flow path and is also withdrawn from the housing to allow air flow through the fourth flow path.

Numbered Paragraph 20: The HVAC system of any one of Numbered Paragraphs 15-19, further comprising a divider positioned across the heat exchanger at a position between the first and second positions of the heat exchanger, wherein the divider prevents or substantially prevents air flowing through the first portion of the heat exchanger from flowing into the second portion of the heat exchanger within a body of the heat exchanger and the divider prevents or substantially prevents air flowing through the second portion of the heat exchanger from flowing into the first portion of the heat exchanger within the body of the heat exchanger,
wherein the housing further comprises a wall disposed therein, the wall comprises a first end that extends from proximate to an end of the divider at the second surface of the heat exchanger and the wall extends above a portion of the first valve, wherein air flowing just above the wall flows toward the fourth flow path.

Numbered Paragraph 21: The HVAC system of Numbered Paragraph 20, wherein the housing further comprises a second wall that is spaced from a second end of the first wall, wherein a space between the second end of the first wall and the second wall establishes the fourth flow path, wherein when the first valve is in the second position the blocking portion extends across the space to prevent air flow into the fourth flow path, and when the first valve is in the third position, the second portion of the blocking portion is aligned with the second wall to allow air flow across the space between the air flow extends between the blocking portion and the second wall to allow air flow through the fourth flow path.

Numbered Paragraph 22: The HVAC system of either of Numbered Paragraph 20 or 21, further comprising a second valve disposed downstream of the first air outlet, wherein when the second valve is in a first position air that flows through the second air inlet and the second portion of the heat exchanger can flow past the second valve and toward the second air outlet, and when the second valve is disposed in a second position air that flows through the second air inlet and the second portion of the heat exchanger is prevented from flowing to the second air outlet.

Numbered Paragraph 23: The HVAC system of Numbered Paragraph 22, wherein the second valve is a barrel valve, wherein the barrel valve comprises an inlet aperture, and outlet aperture, and shroud that establishes a flow path between the inlet and outlet apertures, the shroud prevents air flow into the flow path other than from the inlet and outlet apertures.

Numbered Paragraph 24: The HVAC system for a vehicle of either of Numbered Paragraph 22 or 23, wherein when the second valve is disposed in a first position the inlet aperture is aligned with the heat exchanger and the outlet aperture is aligned to allow air flowing through the flow path to flow through the first air outlet, and
wherein when the second valve is disposed in a second position the shroud is aligned within the first air outlet to prevent air flow from the heat exchanger through the first air outlet.

Numbered Paragraph 25: The HVAC system for a vehicle of either of Numbered Paragraph 23 or 24, wherein the shroud blocks air flow from the first air inlet to the first air outlet when the second valve in the first position and when in the second position.

Numbered Paragraph 26: The HVAC system for a vehicle of any one of Numbered Paragraphs 23-25, wherein the shroud is withdrawn from proximate to the heat exchanger when the second valve is in the second position, such that the second valve allows air flow from the first air inlet to the second portion of the heat exchanger through the first surface of the heat exchanger.

Numbered Paragraph 27: The HVAC system for a vehicle of any one of Numbered Paragraphs 23-26, wherein when the second valve is in the second position and the first valve is in the first position, air can flow from the second portion of the heat exchanger and out of the heat exchanger through the second surface thereof and air flows through the inner volume of the first valve and to the fourth flow path.

Numbered Paragraph 28: The HVAC system for a vehicle of any one of Numbered Paragraphs 23-27, wherein the shroud comprises a curved circumferential portion that extends between the inlet aperture and the outlet aperture, and further comprises parallel and spaced apart first and second side panels that extend between the inlet aperture and outlet aperture.

Numbered Paragraph 29: The HVAC system of any one of Numbered Paragraphs 23-28, wherein the position of the first valve and the position of the second valve is controlled by a controller to facilitate the air flow through the HVAC system.

Numbered Paragraph 30: A method for operating an HVAC system, comprising:
providing the HVAC system of any one of Numbered Paragraphs 22-29,
further providing a third valve disposed in conjunction with an air inlet upstream of the blower that controls air flow from a passenger compartment of the vehicle toward the blower, wherein when the third valve is open, air from the passenger compartment of the vehicle is drawn into the HVAC system and into the blower, and when the third valve is closed, air from within the passenger compartment of the vehicle is prevented from being drawn into the HVAC system and into the blower;
wherein a controller is configured to control the positions of the first valve, the second valve, and the third valve,
wherein the controller receives a first input representative of a velocity that the vehicle is traveling,
wherein when the first input indicates that the vehicle is not moving or is moving at a velocity below a threshold velocity, causing the first valve to be in the second position, and the third valve to be in the open position,
wherein when the first input indicates that the vehicle is moving at a velocity above the threshold velocity, the controller causes the first valve and the second valve to each move to the first position.

Numbered Paragraph 31: The method for operating an HVAC system of Numbered Paragraph 30, wherein the controller receives a second input representative of an air temperature outside of the vehicle.

Numbered Paragraph 32: The method for operating an HVAC system of either of Numbered Paragraph 30 or 31, further comprising when the first input indicates that the vehicle is moving at a velocity above the threshold velocity causing the third valve to move to a position between the open and closed position to allow some flow therethrough but less flow than when the third valve is in the open position.

Numbered Paragraph 33: The method of Numbered Paragraph 32, further comprising causing the third valve to move further toward the closed position as the vehicle velocity further increases above the threshold velocity.

Numbered Paragraph 34: The method for operating an HVAC system of any one of Numbered Paragraphs 30-33, wherein the first input is representative of a velocity of vehicle travel in a forward direction.

Numbered Paragraph 35: The method for operating an HVAC system of any one of Numbered Paragraphs 30-34, wherein the second valve is in a position between the first and second positions when the first input indicates that the vehicle is not moving or is moving at a velocity less than the threshold velocity.

Numbered Paragraph 36: The method for operating an HVAC system of any one of Numbered Paragraphs 30-35, wherein the first and second valves reach the open position when the first input indicates that the velocity reaches the threshold velocity.

Numbered Paragraph 37: A method of operating an HVAC system for a vehicle, comprising:
providing a heat exchanger configured to be disposed within a vehicle, the heat exchanger comprises a first surface and an opposite second surface, wherein a body of the heat exchanger is disposed between the first and second surfaces, wherein the body includes a first portion and a second portion that is different from the first portion;
a first air inlet configured, when installed within the vehicle, to receive air that flows therein from a blower through the first surface, wherein the blower can receive either air from a passenger compartment of the vehicle and/or air from outside of the vehicle, wherein air is directed to flow from the blower through the first inlet and into the first portion of the heat exchanger;
a second air inlet different from the first air inlet, the second air inlet disposed to direct air received therethrough into the second portion of the heat exchanger, the second air inlet configured to receive air that flows therein from within a passenger compartment of the vehicle;
the heat exchanger is disposed to direct air from the first air inlet through the first portion of the heat exchanger and the heat exchanger is disposed to direct air from the second air inlet through the second portion of the heat exchanger simultaneously;
wherein the first air inlet is positioned to cause air flow through the heat exchanger at a first position within the heat exchanger that is vertically above a second position within the heat exchanger,
further providing a first air outlet configured to receive air from the heat exchanger that flowed from the second air inlet and through the second portion of the heat exchanger, wherein the first air outlet is aligned to direct air that flows into the first air outlet to flow outside of the vehicle,
operating a first valve disposed at the second air inlet, wherein the first valve is positionable in a first position to allow air to flow into the heat exchanger through the second air inlet, and a second position to prevent or substantially prevent air to flow into the heat exchanger through the second air inlet,
operating a second valve disposed downstream of the first air outlet, wherein when the second valve is in a first position air that flows through the second air inlet and the second portion of the heat exchanger can flow through the second valve and toward the second air outlet, and when the second valve is disposed in a second position air that flows through the second air inlet and the second portion of the heat exchanger is prevented from flowing to the second air outlet,
further operating a third valve disposed in conjunction with an air inlet upstream of the blower that controls air flow from a passenger compartment of the vehicle toward the blower, wherein when the third valve is open, air from the passenger compartment of the vehicle is drawn into the HVAC system and into the blower, and when the third valve is closed, air from within the passenger compartment of the vehicle is prevented from being drawn into the HVAC system and into the blower;
wherein a controller is configured to control the positions of the first valve, the second valve, and the third valve,
wherein the controller receives a first input representative of a velocity that the vehicle is traveling,
wherein when the first input indicates that the vehicle is not moving or is moving at a velocity below a threshold velocity, causing by way of the controller the first valve to be in the second position, and the third valve to be in the open position,
   wherein when the first input indicates that the vehicle is moving at a velocity above the threshold velocity, causing by way of the controller the first valve and the second valve to each move to the first position.

Numbered Paragraph 38: The method for operating an HVAC system of Numbered Paragraph 37, further comprising causing when the vehicle is moving above the threshold velocity, by way of the controller, the third valve to move toward the closed position and be maintained in a mid position between the open position and a closed position to allow some passenger compartment air to pass therethrough when the velocity is at or above the threshold velocity, wherein a percentage of movement toward the closed position is proportional to the magnitude of the velocity above the threshold velocity.

Numbered Paragraph 39: The method of Numbered Paragraph 38, wherein causing, by way of the controller, the third valve to be in the mid position when the velocity is at or above a second threshold velocity that is a set value above the threshold velocity.

Numbered Paragraph 40: The method for operating an HVAC system of any one of Numbered Paragraphs 37-39, wherein the first input is representative of a velocity of vehicle travel in a forward direction.

Numbered Paragraph 41: The method for operating an HVAC system of any one of Numbered Paragraphs 37-40, causing, by way of the controller, the second valve to be in a position between the first and second positions when the first input indicates that the vehicle is not moving or is moving at a velocity less than the threshold velocity.

Numbered Paragraph 42: The method for operating an HVAC system of any one of Numbered Paragraph 37-41, wherein the first and second valves reach the open position when the first input indicates that the velocity reaches the threshold velocity.

Numbered Paragraph 43: The HVAC system of any one of Numbered Paragraphs 1-29, wherein the heat exchanger has an internal flow path for heat exchange fluid to flow therethrough and the heat exchanger has a heat exchange fluid inlet and an outlet, further comprising a flow path to allow heat exchange fluid to flow directly from the heat exchange outlet to the heat exchange inlet.

Numbered Paragraph 44: The HVAC system of Numbered Paragraph 43, further comprising one or more isolation valves within the flow path to allow heat exchange fluid to flow directly from the heat exchange outlet to the heat exchange inlet, wherein the one or more isolation valves are configured to be positioned to allow or prevent flow therethrough.

Numbered Paragraph 45: The HVAC system of either of Numbered Paragraph 43 or 44, further comprising a pump within the flow path to allow heat exchange fluid to flow directly from the heat exchange outlet to the heat exchange inlet.

1. A HVAC system for a vehicle, comprising:
a heat exchanger configured to be disposed within a vehicle, the heat exchanger comprises a first surface and an opposite second surface, wherein a body of the heat exchanger is disposed between the first and second surfaces, wherein the body includes a first portion and a second portion that is different from the first portion;
a first air inlet configured, when installed within the vehicle, to receive air that flows therein from a blower through the first surface, wherein the blower can receive either air from a passenger compartment of the vehicle and/or air from outside of the vehicle, wherein air is directed to flow from the blower through the first inlet and into the first portion of the heat exchanger;
a second air inlet different from the first air inlet, the second air inlet disposed to direct air received therethrough into the second portion of the heat exchanger, the second air inlet configured to receive air that flows therein from within a passenger compartment of the vehicle;
the heat exchanger is disposed to direct air from the first air inlet through the first portion of the heat exchanger and the heat exchanger is disposed to direct air from the second air inlet through the second portion of the heat exchanger simultaneously;
wherein the first air inlet is positioned to cause air flow through the heat exchanger at a first position within the heat exchanger that is vertically above a second position within the heat exchanger,
further comprising a first air outlet configured to receive air from the heat exchanger that flowed from the second air inlet and through the second portion of the heat exchanger, wherein the first air outlet is aligned to direct air that flows into the first air outlet to flow outside of the vehicle,
wherein the second air inlet comprises a first valve disposed therein, wherein the first valve is positionable in a first position to allow air to flow into the heat exchanger through the second air inlet, and a second position to prevent or substantially prevent air to flow into the heat exchanger through the second air inlet,
the first valve extends along a cylindrical profile with an outer circumference that extends along a length thereof between first and second ends, wherein a portion of the outer circumference includes a blocking portion to prevent air flow past the blocking portion and into an inner volume of the cylinder, and a portion of the outer circumference is not blocked to allow flow therethrough and into the inner volume.

2. The HVAC system of claim 1, wherein the blocking portion further comprises an inner wall that extends therethrough along a path through an inner volume of the cylinder, wherein the inner wall extends between opposite ends disposed upon the outer circumference, wherein the path of the inner wall remains on one side of a center axis along an entire length of the path between the opposite ends.

3. The HVAC system of claim 2, wherein the path extends between the first and second ends of the cylinder.

4. The HVAC system of claim 3, wherein the blocking portion comprises a first end that intersects with a first end of the inner surface and the blocking portion comprises a second end that intersects with a second end of the inner surface, wherein the blocking portion includes a second portion that is recessed inwardly of circumferential profile between the first and second ends of the blocking portion.

5. The HVAC system of claim 4, further comprising a housing, wherein the first valve and the heat exchanger are supported within the housing;
wherein the housing establishes a first flow path from the blower to the first surface of the heat exchanger, a second flow path from the second surface and the first portion of the heat exchanger, a third flow path from a passenger compartment within the vehicle, through the first valve and into the second portion of the heat exchanger, and a fourth flow path from the first portion and the second surface of the heat exchanger that leads into the passenger compartment,
wherein the first valve is rotatably supported within the housing between three positions, a first position where the blocking portion is aligned with the third flow path to prevent air flow therethrough and into the second portion of the heat exchanger, a second position where the blocking portion is withdrawn from the third flow path such that air that approaches the first valve from the third flow path can flow into the inner volume of the cylinder and into the second portion of the heat exchanger but where the blocking portion corresponds with the housing to prevent air flow through the fourth flow path, and a third position where the blocking portion is withdrawn from the third flow path and is also withdrawn from the housing to allow air flow through the fourth flow path.

6. The HVAC system of claim 5, further comprising a divider positioned across the heat exchanger at a position between the first and second positions of the heat exchanger, wherein the divider prevents or substantially prevents air flowing through the first portion of the heat exchanger from flowing into the second portion of the heat exchanger within a body of the heat exchanger and the divider prevents or substantially prevents air flowing through the second portion of the heat exchanger from flowing into the first portion of the heat exchanger within the body of the heat exchanger,
wherein the housing further comprises a wall disposed therein, the wall comprises a first end that extends from proximate to an end of the divider at the second surface of the heat exchanger and the wall extends above a portion of the first valve, wherein air flowing just above the wall flows toward the fourth flow path.

7. The HVAC system of claim 6, wherein the housing further comprises a second wall that is spaced from a second end of the first wall, wherein a space between the second end of the first wall and the second wall establishes the fourth flow path, wherein when the first valve is in the second position the blocking portion extends across the space to prevent air flow into the fourth flow path, and when the first valve is in the third position, the second portion of the blocking portion is aligned with the second wall to allow air flow across the space between the air flow extends between the blocking portion and the second wall to allow air flow through the fourth flow path.

8. The HVAC system of claim 6, further comprising a second valve disposed downstream of the first air outlet, wherein when the second valve is in a first position air that flows through the second air inlet and the second portion of the heat exchanger can flow past the second valve and toward the second air outlet, and when the second valve is disposed in a second position air that flows through the second air inlet and the second portion of the heat exchanger is prevented from flowing to the second air outlet.

9. The HVAC system of claim 8, wherein the second valve is a barrel valve, wherein the barrel valve comprises an inlet aperture, and outlet aperture, and shroud that establishes a flow path between the inlet and outlet apertures, the shroud prevents air flow into the flow path other than from the inlet and outlet apertures.

10. The HVAC system for a vehicle of claim 9, wherein when the second valve is disposed in a first position the inlet aperture is aligned with the heat exchanger and the outlet aperture is aligned to allow air flowing through the flow path to flow through the first air outlet, and
wherein when the second valve is disposed in a second position the shroud is aligned within the first air outlet to prevent air flow from the heat exchanger through the first air outlet.

11. The HVAC system for a vehicle of claim 10, wherein the shroud blocks air flow from the first air inlet to the first air outlet when the second valve in the first position and when in the second position.

12. The HVAC system for a vehicle of claim 10, wherein the shroud is withdrawn from proximate to the heat exchanger when the second valve is in the second position, such that the second valve allows air flow from the first air inlet to the second portion of the heat exchanger through the first surface of the heat exchanger.

13. The HVAC system for a vehicle of claim 12, wherein when the second valve is in the second position and the first valve is in the first position, air can flow from the second portion of the heat exchanger and out of the heat exchanger through the second surface thereof and air flows through the inner volume of the first valve and to the fourth flow path.

14. The HVAC system for a vehicle of claim 9, wherein the shroud comprises a curved circumferential portion that extends between the inlet aperture and the outlet aperture, and further comprises parallel and spaced apart first and second side panels that extend between the inlet aperture and outlet aperture.

15. The HVAC system of claim 10, wherein the position of the first valve and the position of the second valve is controlled by a controller to facilitate the air flow through the HVAC system.

16. A method for operating an HVAC system, comprising:
providing the HVAC system of claim 8,
further providing a third valve disposed in conjunction with an air inlet upstream of the blower that controls air flow from a passenger compartment of the vehicle toward the blower, wherein when the third valve is open, air from the passenger compartment of the vehicle is drawn into the HVAC system and into the blower, and when the third valve is closed, air from within the passenger compartment of the vehicle is prevented from being drawn into the HVAC system and into the blower;
wherein a controller is configured to control the positions of the first valve, the second valve, and the third valve,
wherein the controller receives a first input representative of a velocity that the vehicle is traveling,
wherein when the first input indicates that the vehicle is not moving or is moving at a velocity below a threshold velocity, causing the first valve to be in the second position, and the third valve to be in the open position,
wherein when the first input indicates that the vehicle is moving at a velocity above the threshold velocity, the controller causes the first valve and the second valve to each move to the first position.

17. The method for operating an HVAC system of claim 16, further comprising when the first input indicates that the vehicle is moving at a velocity above the threshold velocity causing the third valve to move to a position between the open and closed position to allow some flow therethrough but less flow than when the third valve is in the open position.

18. The method for operating an HVAC system of claim 17, further comprising causing the third valve to move further toward the closed position as the vehicle velocity further increases above the threshold velocity.

19. The method for operating an HVAC system of claim 16, wherein the second valve is in a position between the first and second positions when the first input indicates that the vehicle is not moving or is moving at a velocity less than the threshold velocity.

20. The method for operating an HVAC system of claim 16, wherein the first and second valves reach the open position when the first input indicates that the velocity reaches the threshold velocity.
